(19) United States
(12) Patent Application Publication
(10) Pub. No.: US 2011/0262853 A1
(43) Pub. Date: Oct. 27, 2011

(54) TONER, DEVELOPER, AND IMAGE FORMING METHOD

(76) Inventors: Masaki WATANABE, Shizuoka (JP); Hiroshi Yamashita, Shizuoka (JP); Tomoki Murayama, Miyagi (JP)

(21) Appl. No.: 13/086,677

(22) Filed: Apr. 14, 2011

(30) Foreign Application Priority Data
Apr. 21, 2010 (JP) 2010-097968

(51) Int. Cl. G03G 9/08; G03G 21/00

(52) U.S. Cl. 430/108.4; 430/137.1; 430/119.86

(57) ABSTRACT

A toner containing a fatty acid having 6 to 22 carbon atoms, and a binder resin, wherein the toner is obtained by a method for producing a toner, which contains dissolving or dispersing in an organic solvent the fatty acid having 6 to 22 carbon atoms, and a toner material containing at least the binder resin, so as to prepare a solution or dispersion liquid, emulsifying or dispersing the solution or dispersion liquid in an aqueous medium containing acrylic resin fine particles, so as to prepare an emulsion or dispersion liquid, and removing the organic solvent from the emulsion or dispersion liquid.

### BACKGROUND OF THE INVENTION

1. Field of the Invention

The present invention relates to a toner for developing an electrostatic image by electrophotography, electrostatic recording and electrostatic printing, etc.; a developer; a process cartridge; an image forming method; and an image forming apparatus.

2. Description of the Related Art

In recent years, small copiers that can swiftly form a great number of images, while maintaining high-quality images are in high demand; however, not all recent copiers have been successfully downsized. This is because the required space for housing collected toner particles remaining after transferring toner images is large in copiers. By supplying the collected toner particles to a developing unit, small and high-speed copiers adaptable to environmental problems, can be achieved. Moreover, with respect to the supplying toner, the number of sheet capable of copying increases, to thereby decrease cost per copy, and improve economic efficiency.

Many attempts have been made to supply the collected remaining toner to a developer for performing development. However, there are problems such as degradation of image quality, and decrease in image density and image stability for a long period of time.

To solve above-mentioned problems, techniques for regulating a particle size distribution of a developer have been proposed (for examples, see Japanese Patent Application Laid-Open (JP-A) No. 02-157765 and Japanese Patent (JP-B) No. 2896826).

JP-A No. 02-157765 proposes a technique of preventing fogging, toner scattering, or the like when a toner is reused using a toner powder, in which 90% by mass or more of toner particles have a diameter from D(³√2) to ³√2D, and 5% by mass or less have a diameter smaller than D(³√2), where D is the volume average particle diameter of the particles. However, the technique has a problem that a copy in which fine latent image is faithfully reproduced cannot be obtained.

In JP-B No. 2896826 a toner having a specific particle size distribution is proposed. However, the technique has a problem of occurrence of carrier spent or fogging by reusing the toner.

In electrophotographic image formation, by fixing a toner on an image support by a heat fixing method, a permanent visible copied image can be obtained. When a transparency sheet for use in an overhead projector (hereinafter referred to as “OHP sheet”) is used as an image support and a copied image is formed thereon using a toner, particularly using a color toner, it is required to fix the image having a smooth surface so as to enhance the optical transmittance in the case of projecting the image by an overhead projector. That is, it is required to fix the toner image smoothly on the OHP sheet surface so as to prevent the scatter and irregular reflection of transmitted light on the image surface upon projecting the image.

In order to achieve the above object, conventionally, a color toner which can rapidly transit to a molten state of a visco-elasticity lower than that of conventional black toner at the melting temperature thereof is used, and the surface of a formed color toner image is easily smoothed by heating and pressing.

However, when the visco-elasticity of toner is lowered, the glass transition temperature of the toner also decreases. Therefore, at a normal temperature or a temperature in a machine using the toner, the mechanical strength of the toner decreases. Accordingly, when a mechanical stress is applied to the toner particle by stirring it in a developing unit, an external additive on the surface of the toner particle is embedded therein, causing deterioration of the developing ability and transferability of the toner. Further, toner particles adhering to carrier particles, so-called toner spent occurs. These problems remarkably occur in the case where the sizes of toner particles are reduced to enhance the image quality in recent years. This is because the toner particle is easily susceptible to mechanical stress, according to decrease in size of the toner particle.

To solve the above-described problems, there is a proposal of technique of improving OHP permeability by using a toner, in which a volume average particle diameter Dv (λm) and a storage modulus G′ 170 (dyne/cm²) thereof at 170° C. satisfy a certain relation (for example, see JP-B No. 3885241). However, in the technique, theoretically, the smaller the average particle size of a toner becomes, the larger the storage modulus thereof becomes, causing disadvantages to the low temperature fixing ability and the glossiness. Consequently, color reproducibility is degraded. That is, both the improvement of image quality by decreasing a particle size of a toner in recent years and the low temperature fixing ability and color reproducibility of the toner cannot be satisfied at the same time.

In order to enhance the low temperature fixing ability of the toner, a technique of using a binder resin for the toner, which contains a specific crystalline polyester and an amorphous hybrid resin, has been proposed. (for example, see JP-A No. 2004-191516). However, in the technique, there are problems of occurrence of fogging and uneven image density, which are caused by incompatibility of the crystalline polyester with a pigment.

In order to enhance the low temperature fixing ability of the toner, a technique of attempting the improvement of the low temperature fixing ability by incorporating in the toner a plasticizer insoluble to an organic solvent in addition to the crystalline polyester has been proposed. However, in the technique, it is essential to use a dispersant, and there is a problem of increase in the lower limit fixing temperature.

In order to enhance the low temperature fixing ability of the toner, a binder resin for the toner, which contains an amorphous polyester and a crystalline polyester, has been proposed (for example, see JP-A No. 2001-222138). However, in the case where the amorphous polyester and the crystalline polyester are used in combination, since both resins have similar compositions, transesterification reaction occurs during melting and kneading the polyesters, and high crystallinity of the crystalline polyester cannot be maintained, causing decrease in storage stability of the toner.

In order to enhance the low temperature fixing ability of the toner, as a binder resin, there is a proposed technique of using a crystalline polyester containing 60% by mole of the structure represented by the following formula based on the total ester bond in the total resin (for example, see JP-A No. 2005-338814):

—OCOC—R—COO—(CH₂)n-

in the formula, R denotes a linear unsaturated aliphatic group having 2 to 20 carbon atoms, and n denotes an integer of 2 to 20. However, in the technique, there is a problem of poor storage stability of the toner.

In order to enhance storage stability at low temperature and fixing ability at low speed of the toner, there is a proposal of a binder resin for a toner, which contains a crystalline polyester containing sebacic acid or adipic acid as a carboxylic acid component, and a styrene-acrylic resin (for example, see JP-A Nos. 11-249339 and 2003-302791). However, in the technique, there is a problem of insufficiency of other properties.

### BRIEF SUMMARY OF THE INVENTION

The present invention solves the above problems, and achieves the following object. That is, an object of the present invention is to provide a toner having excellent low temperature fixing ability, spent resistance and heat resistant storage stability, and capable of forming a high quality image having excellent sharpness for a long period of time, and a developer, a process cartridge, an image forming method, and an image forming apparatus.

Means for solving the above problems is as follows.

<1> A toner containing: a fatty acid having 6 to 22 carbon atoms; and a binder resin, wherein the toner is obtained by a method for producing a toner, which includes: dissolving or dispersing in an organic solvent the fatty acid having 6 to 22 carbon atoms, and a toner material containing at least the binder resin, so as to prepare a solution or dispersion liquid; emulsifying or dispersing the solution or dispersion liquid in an aqueous medium containing acrylic resin fine particles, so as to prepare an emulsion or dispersion liquid; and removing the organic solvent from the emulsion or dispersion liquid.
<2> The toner according to <1>, wherein the fatty acid is in a form of liquid or solid at 25° C.±5° C.
<3> The toner according to any of <1> to <2>, wherein the fatty acid in the organic solvent is 10% by mass or more.
<4> The toner according to any of <1> to <3>, wherein, in the dissolving or dispersing in the organic solvent, the amount of the fatty acid is 1.0 part by mass to 20.0 parts by mass, relative to 100 parts by mass of the binder resin.
<5> The toner according to any of <1> to <4>, wherein the fatty acid has 0 to 2 double bonds.
<6> The toner according to <1> to <5>, wherein the binder resin is a polyester resin.
<7> The toner according to any of <1> to <6>, wherein the binder resin has a glass transition temperature Tg of 30° C. to 70° C.
<8> The toner according to any of <1> to <7>, wherein an amount of the fatty acid is 0.1 parts by mass to 20.0 parts by mass, relative to 100 parts by mass of the toner.
<9> The toner according to any of <1> to <8>, wherein the toner has a glass transition temperature Tg of 20° C. to 55° C.
<10> The toner according to any of <1> to <9>, wherein the acrylic resin fine particles are localized near a surface of the toner in a form of particles, so as to form a layer of particles.
<11> The toner according to any of <1> to <10>, wherein the toner has a volume average particle diameter of 3 μm to 7 μm.
<12> The toner according to any of <1> to <11>, wherein a ratio of a volume average particle diameter to a number average particle diameter of the toner is 1.05 to 1.25.
<13> The toner according to any of <1> to <12>, wherein the toner has an average circularity of 0.950 to 0.990.
<14> The toner according to any of <1> to <13>, wherein the toner has a BET specific surface area of 0.5 m²/g to 4.0 m²/g.
<15> The toner according to any of <1> to <14>, wherein the toner material contains an active hydrogen group-containing compound, and a modified polyester resin reactive with the active hydrogen group-containing compound.
<16> A developer containing the toner according to any of <1> to <15>.
<17> An image forming method including: charging a surface of an electrophotographic photoconductor; exposing the charged surface of the electrophotographic photoconductor to light so as to form a latent electrostatic image; developing the latent electrostatic image using the toner according to any of <1> to <15> so as to form a visible image; transferring the visible image directly or via an intermediate transfer medium onto a recording medium; fixing the transferred visible image onto the recording medium; and cleaning the toner remaining on the surface of the electrophotographic photoconductor.
<18> An image forming method according to <17>, wherein the transferring the visible image via the intermediate transfer medium onto the recording medium is performed by a secondary transfer unit, a linear velocity of transferring the visible image onto the recording medium is 300 mm/sec to 1,000 mm/sec, and a transfer time at a nip portion in the secondary transfer unit is 0.5 msec to 20 msec.
<19> An image forming apparatus including: an electrophotographic photoconductor; a charging unit configured to charge a surface of the electrophotographic photoconductor; an exposing unit configured to expose the charged surface of the electrophotographic photoconductor to light so as to form a latent electrostatic image; a developing unit configured to develop the latent electrostatic image using the toner according to any of <1> to <15> so as to form a visible image; a transfer unit configured to transfer the visible image directly or via an intermediate transfer medium onto a recording medium; a fixing unit configured to fix the transferred visible image onto the recording medium; and a cleaning unit configured to clean the toner remaining on the electrophotographic photoconductor.
<20> The image forming apparatus according to <19>, wherein the image forming apparatus includes tandemly-arranged plurality of image forming elements, each of which includes at least the electrophotographic photoconductor, the charging unit, the exposing unit, and the developing unit.
<21> A process cartridge including at least an electrophotographic photoconductor, and a developing unit configured to develop a latent electrostatic image formed on the electrophotographic photoconductor using the toner according to any of <1> to <15>, so as to form a visible image, wherein the process cartridge is detachably attached to an image forming apparatus.
<22> The process cartridge according to <21>, further includes at least one selected from a charging unit, a transfer unit and a cleaning unit.

According to the present invention, the conventional problems can be solved, achieves the objects, and there can be provided a toner having excellent low temperature fixing ability, spent resistance and heat resistant storage stability, and capable of forming a high quality image having excellent sharpness for a long period of time, and a developer, a process cartridge, an image forming method, and an image forming apparatus.

### BRIEF DESCRIPTION OF THE DRAWINGS

FIG. 1 is a schematic view of one exemplary contact-type roller charging device.

FIG. 2 is a schematic view of one exemplary contact-type brush charging device.

FIG. 3 is a schematic view of one exemplary magnetic brush charging device

FIG. 4 is a schematic view of one exemplary developing device.

FIG. 5 is a schematic view of one exemplary fixing device.

FIG. 6 is a view showing one exemplary layer structure of a fixing belt.

FIG. 7 is a schematic view of one exemplary process cartridge.

FIG. 8 is a schematic view of one exemplary image forming apparatus.

FIG. 9 is a schematic view of another exemplary image forming apparatus.

FIG. 10 is a SEM picture (magnification 4,000×) showing that shell particles uniformly cover a surface layer, specifically, acrylic resin particles are localized near a surface of the toner in the form of particles, so as to form a layer of the particles.

FIG. 11 is an enlarged view of an area surrounded by a broken line in FIG. 10, and a SEM picture (magnification 10,000×) showing that shell particles uniformly cover a surface layer, specifically, acrylic resin particles are localized near a surface of the toner in the form of particles, so as to form a layer of the particles.

FIG. 12 is a further enlarged view of FIG. 11, and a SEM picture (magnification 20,000×) showing that shell particles uniformly cover a surface layer, specifically, acrylic resin particles are localized near a surface of the toner in the form of particles, so as to form a layer of the particles.

### DETAILED DESCRIPTION OF THE INVENTION

### (Toner)

The toner of the present invention is produced by a method for producing a toner, which includes a solution or dispersion liquid preparing step, an emulsion or dispersion liquid preparing step, and an organic solvent removing step, and contains a fatty acid having 6 to 22 carbon atoms.

### <Solution or Dispersion Liquid Preparing Step>

The solution or dispersion liquid preparing step is a step of dissolving or dispersing in an organic solvent a toner material containing at least a binder resin, and fatty acid having 6 to 22 carbon atoms, so as to prepare a solution or dispersion liquid.

### —Fatty Acid—

The fatty acid is not particularly limited and may be appropriately selected depending on the intended purpose, as long as it dissolves in an organic solvent, and exhibits plasticization effect on a binder resin.

The number of a carbon atom of the fatty acid is not particularly limited and may be appropriately selected depending on the intended purpose, as long as it is 6 to 22. It is preferably 8 to 12.

When the number of the carbon atom of the fatty acid is less than 6, heat resistant storage stability and resistance to carrier contamination of a toner may be degraded. When the number of the carbon atom of the fatty acid is more than 22, low temperature fixing ability may not be obtained. On the other hand, the number of the carbon atom of the fatty acid within the above-described preferable range is advantageous in that both low temperature fixing ability and storage stability are satisfied.

The number of a double bond of the fatty acid is preferably 0 to 2. When the number of the double bond is greater than 2, a melting point is significantly lowered, and the plasticizer oozes out from the toner at room temperature (25° C.), causing decrease in the resistance to carrier contamination.

The amount of the fatty acid in the organic solvent is not particularly limited and may be appropriately selected depending on the intended purpose. It is preferably 10% by mass or more.

When the amount of the fatty acid in the organic solvent is less than 10% by mass, the amount of the plasticizer that cannot enter inside the crosslink skeleton of the resin increases, failing to sufficiently obtain plasticizing effect. On the other hand, when the amount of the fatty acid in the organic solvent is within the preferable range, the plasticizer sufficiently enters inside the crosslink skeleton of the resin, and is advantageous in terms of sufficiently exhibiting plasticizing effect.

The amount added of the fatty acid in the solution or dispersion liquid preparing step is not particularly limited and may be appropriately selected depending on the intended purpose. It is preferably 0.01 parts by mass to 20.0 parts by mass, more preferably 1.0 part by mass to 20.0 parts by mass, still more preferably 1.0 part by mass to 5.0 parts by mass, particularly preferably 1.0 part by mass to 3.0 parts by mass, relative to 100 parts by mass of the binder resin.

When the amount added of the fatty acid in the solution or dispersion liquid preparing step is less than 1.0 part by mass relative to 100 parts by mass of the binder resin, the plasticizing effect may not be sufficiently obtained. When the amount added of the fatty acid is more than 20.0 parts by mass, the plasticizer bleeds out, possibly causing decrease in the heat resistant storage stability and the resistance to carrier contamination. On the other hand, when the amount added of the fatty acid in the solution or dispersion liquid preparing step is within the particularly preferable range, it is advantageous in that fixation at low temperature, the heat resistant storage stability, and the resistance to carrier contamination can be satisfied.

The amount of the fatty acid in the toner is not particularly limited and may be appropriately selected depending on the intended purpose. It is preferably 0.1 parts by mass to 20.0 parts by mass, more preferably 1.0 part by mass to 3.0 parts by mass, relative to 100 parts by mass of the toner. When the amount of the fatty acid is less than 0.1 parts by mass relative to 100 parts by mass of the toner, causing decrease in the softening effect of the resin, and possibly insufficiently exhibiting the low temperature fixing ability. When the amount of the fatty acid is more than 20.0 parts by mass, the plasticizer bleeds out on the toner surface, adversely affecting heat resistant storage stability, and causing contamination of a carrier. Consequently, a desired charge amount may not be obtained.

The fatty acid may be in the form of liquid or solid, at 25° C.±5° C.

In the case where the fatty acid is liquid, it is directly added to an organic solvent such as ethyl acetate, and in the case where the fatty acid is solid, it is preferred that the fatty acid be dissolved in ethyl acetate before addition. The dissolution of the fatty acid in the organic solvent can be judged as follows: in the case where the fatty acid is liquid, one can judge that it has been dissolved in the organic solvent based on the fact that the liquid is not separated into two layers; in the case where the fatty acid is solid, one can judge that it has been dissolved in the organic solvent based on the fact that it is transparent by visual observation.

### —Organic Solvent—

The organic solvent is not particularly limited, as long as it allows the toner material and the fatty acid to be dissolved or dispersed therein, and may be appropriately selected depending on the intended purpose. It is preferable that the organic solvent be a solvent having a boiling point of lower than 150° C. in terms of easy removal during or after formation of the toner particles. Specific examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. Among these solvents, ester solvents are preferable, with ethyl acetate being particularly preferable.

These solvents may be used alone or in combination.

The amount of the organic solvent is not particularly limited and may be appropriately selected depending on the intended purpose. The amount of the organic solvent is preferably 40 parts by mass to 300 parts by mass, more preferably 60 parts by mass to 140 parts by mass, still more preferably 80 parts by mass to 120 parts by mass, relative to 100 parts by mass of the toner material.

The solution or dispersion liquid can be prepared by dissolving or dispersing in the organic solvent the toner material containing at least a binder resin, and further containing an active hydrogen group-containing compound, a polymer reactive with the active hydrogen group-containing compound, an unmodified polyester resin, a releasing agent, a colorant and a charge controlling agent. Of the toner material, components other than the polymer (prepolymer) reactive with the active hydrogen group-containing compound may be added and mixed in the aqueous medium in the preparation of the aqueous medium described below, or may be added together with the solution or dispersion liquid in the aqueous medium when the solution or dispersion liquid of the toner material is added to the aqueous medium.

### —Toner Material—

The toner material is not particularly limited and may be appropriately selected depending on the intended purpose, as long as it contains at least a binder resin. The toner material preferably further contains an active hydrogen group-containing compound, a polymer (prepolymer) reactive with the active hydrogen group-containing compound, and a colorant. If necessary, the toner material may further contain other components, such as a releasing agent, and a charge controlling agent. The solution or dispersion liquid of the toner material is preferably prepared by dissolving or dispersing the toner material in an organic solvent. The organic solvent is preferably removed during or after formation of a toner.

### —Binder Resin—

The binder resin is not particularly limited and may be appropriately selected depending on the intended purpose. Specific examples thereof include known binder resins, such as polyester resins, silicone resins, styrene-acrylic resins, styrene resins, acrylic resins, epoxy resins, diene resins, phenol resins, terpene resins, coumarin resins, amide imide resins, butyral resins, urethane resins, and ethylene vinyl acetate resins. Of these, polyester resins are particularly preferable because of being sharply melted upon fixing, being capable of smoothing an image surface, having sufficient flexibility even if the molecular weight thereof is lowered. The polyester resins may be used in combination with another resin.

The polyester resins are preferably produced through reaction between one or more polyols represented by the following General Formula (1) and one or more polycarboxylic acids represented by the following General Formula (2):

A-(OH)m General Formula (1)

in General Formula (1), A represents an alkyl group having 1 to 20 carbon atoms, an alkylene group having 1 to 20 carbon atoms, an aromatic group which may have a substituent, or a heterocyclic aromatic group which may have a substituent; and m is an integer of 2 to 4,

B—(COOH)n General Formula (2)

in General Formula (2), B represents an alkyl group having 1 to 20 carbon atoms, an alkylene group having 1 to 20 carbon atoms, an aromatic group which may have a substituent, or a heterocyclic aromatic group which may have a substituent; and n is an integer of 2 to 4.

The polyols represented by General Formula (1) is not particularly limited and may be appropriately selected depending on the intended purpose. Examples of the polyols represented by General Formula (1) include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, bisphenol A, ethylene oxide adducts of bisphenol A, propylene oxide adducts of bisphenol A, hydrogenated bisphenol A, ethylene oxide adducts of hydrogenated bisphenol A, and propylene oxide adducts of hydrogenated bisphenol A.

The polycarboxylic acids represented by General Formula (2) is not particularly limited and may be appropriately selected depending on the intended purpose. Examples of the polycarboxylic acids represented by General Formula (2) include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isooctylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Enpol trimer acid, cyclohexanedicarboxylic acid, cyclohexenedicarboxylic acid, butanetetracarboxylic acid, diphenylsulfonetetracarboxylic acid, and ethylene glycolbis(trimellitic acid).

The weight average molecular weight of the binder resin is not particularly limited and may be appropriately selected depending on the intended purpose. It is preferably 3,000 or higher, more preferably 5,000 to 1,000,000, particularly preferably 7,000 to 500,000, based on the molecular weight distribution obtained by analyzing tetrahydrofuran (THF) soluble matter of the binder resin through gel permeation chromatography (GPC). Since the weight average molecular weight is lower than 3,000, the formed toner may have degraded hot offset resistance.

The gel permeation chromatography (GPC) for measuring the molecular weight distribution can be performed, for example, as follows.

Specifically, a binder resin (0.15% by mass) is dissolved into tetrahydrofuran (THF (for example, containing a stabilizer, manufactured by Wako Pure Chemical Industries, Ltd.)), and filtered using a 0.2 μm filter, to thereby obtain a filtrate as a sample to be measured.

A column (for example, TSKgel Super HZM-H, 15 cm, particle diameter: 3 μm, manufactured by TOSOH CORPORATION) is conditioned in a heat chamber at 40° C., and then tetrahydrofuran (THF) (solvent) is caused to pass through the column at a flow rate of 0.35 mL/min while the temperature is maintained. Subsequently, 400 μL of the sample to be measured is charged and measurement is performed. In the measurement of the molecular weight of the sample, the molecular weight distribution of the sample is determined based on the relationship between the logarithmic value and the count number of a calibration curve given by using several monodisperse polystyrene-standard samples. The polystyrene-standard samples used for giving the calibration curve may be, for example, STANDARD No S-7300, S-210, S-390, S-875, S-1980, S-10.9, S-629, S-3.0, S-0.580 of SHODEX STANDARD available from Showa Denko K.K. and toluene are used. Preferably, at least about 10 polystyrene-standard samples are used for giving the calibration curve. The detector which can be used is a refractive index (RI) detector.

The glass transition temperature, Tg, of the binder resin is not particularly limited and may be appropriately selected depending on the intended purpose. The glass transition temperature of the binder resin is preferably 30° C. to 70° C., more preferably 40° C. to 65° C. When the glass transition temperature, Tg, is lower than 30° C., the formed toner may have degraded heat-resistant storage stability. When the glass transition temperature, Tg, is higher than 70° C., the formed toner may have insufficient low-temperature fixing ability. In an exemplary electrophotographic toner, there exists a polyester resin subjected to crosslinking reaction and elongation reaction. Accordingly, even when the glass transition temperature is lower than that of the conventional polyester toner, excellent storage stability can be realized.

The glass transition temperature, Tg, as used herein is determined in the following manner, using thermal analyzers TA-60WS and DSC-60 (manufactured by Shimadzu Corporation) as measuring devices under the conditions given below.

### Measurement Conditions

Sample container: aluminum sample pan (with a lid)

Sample amount: 5 mg

Reference: aluminum sample pan (10 mg of alumina)

Atmosphere: nitrogen (flow rate: 50 mL/min)

Temperature conditions:
Start temperature: 20° C.
Heating rate: 10° C./min
Finish temperature: 150° C.
Hold time: 0
Cooling rate: 10° C./min
Finish temperature: 20° C.
Hold time: 0
Heating rate: 10° C./min
Finish temperature: 150° C.

The measured results are analyzed using a data analysis software (TA-60, version 1.52) produced by Shimadzu Corporation. The analysis is performed by appointing a range of ±5° C. around a point showing the maximum peak in the lowest temperature side of DrDSC curve, which is the differential curve of the DSC curve in the second heating, and determining the peak temperature using a peak analysis function of the analysis software. Then, the maximum endotherm temperature of the DSC curve is determined in the range of the above peak temperature +5° C. and −5° C. in the DSC curve using a peak analysis function of the analysis software. The temperature shown here corresponds to Tg of the toner.

The polyester resin is not particularly limited and may be appropriately selected depending on the intended purpose. Urea-modified polyester resins, and unmodified polyester resins are preferable. The urea-modified polyester resin is obtained by reacting, in the aqueous medium, amines (B) serving as the active hydrogen group-containing compound and an isocyanate group-containing polyester prepolymer (A) serving as the polymer reactive with the active hydrogen group-containing compound. The urea-modified polyester resin may contain a urethane bonding, as well as a urea bonding. In this case, a molar ratio (urea bonding/urethane bonding) of the urea bonding to the urethane bonding is not particularly limited and may be appropriately selected depending on the intended purpose. It is preferably 100/0 to 10/90, more preferably 80/20 to 20/80, particularly preferably 60/40 to 30/70. In the case where the molar ratio of the urea bonding is less than 10, the formed toner may have degraded hot offset resistance.

Preferred examples of the urea-modified polyester resin and the unmodified polyester resin include the following.

(1) a mixture of: a urea-modified polyester resin which is obtained by modifying, with isophorone diamine, polyester prepolymer which is obtained by reacting isophorone diisocyanate with a polycondensation product of bisphenol A ethylene oxide (2 mol) adduct and isophthalic acid; and a polycondensation product of bisphenol A ethylene oxide (2 mol) adduct and isophthalic acid.

(2) a mixture of: a urea-modified polyester resin which is obtained by modifying, with isophorone diamine, polyester prepolymer which is obtained by reacting isophorone diisocyanate with a polycondensation product of bisphenol A ethylene oxide (2 mol) adduct and isophthalic acid; and a polycondensation product of bisphenol A ethylene oxide (2 mol) adduct and terephthalic acid.

(3) a mixture of: a urea-modified polyester resin which is obtained by modifying, with isophorone diamine, polyester prepolymer which is obtained by reacting isophorone diisocyanate with a polycondensation product of bisphenol A ethylene oxide (2 mol) adduct, bisphenol A propylene oxide (2 mol) adduct and terephthalic acid; and a polycondensation product of bisphenol A ethylene oxide (2 mol) adduct, bisphenol A propylene oxide (2 mol) adduct and terephthalic acid.

(4) a mixture of: a urea-modified polyester resin which is obtained by modifying, with isophorone diamine, polyester prepolymer which is obtained by reacting isophorone diisocyanate with a polycondensation product of bisphenol A ethylene oxide (2 mol) adduct, bisphenol A propylene oxide (2 mol) adduct and terephthalic acid; and a polycondensation product of bisphenol A propylene oxide (2 mol) adduct and terephthalic acid.

(5) a mixture of: a urea-modified polyester resin which is obtained by modifying, with hexamethylene diamine, polyester prepolymer which is obtained by reacting isophorone diisocyanate with a polycondensation product of bisphenol A ethylene oxide (2 mol) adduct and terephthalic acid; and a polycondensation product of bisphenol A ethylene oxide (2 mol) adduct and terephthalic acid.

(6) a mixture of: a urea-modified polyester resin which is obtained by modifying, with hexamethylene diamine, polyester prepolymer which is obtained by reacting isophorone diisocyanate with a polycondensation product of bisphenol A ethylene oxide (2 mol) adduct and terephthalic acid; and a polycondensation product of bisphenol A ethylene oxide (2 mol) adduct, bisphenol A propylene oxide (2 mol) adduct and terephthalic acid.

(7) a mixture of: a urea-modified polyester resin which is obtained by modifying, with ethylene diamine, polyester prepolymer which is obtained by reacting isophorone diisocyanate with a polycondensation product of bisphenol A ethylene oxide (2 mol) adduct and terephthalic acid; and a polycondensation product of bisphenol A ethylene oxide (2 mol) adduct and terephthalic acid.

(8) a mixture of: a urea-modified polyester resin which is obtained by modifying, with hexamethylene diamine, polyester prepolymer which is obtained by reacting diphenylmethane diisocyanate with a polycondensation product of bisphenol A ethylene oxide (2 mol) adduct and isophthalic acid; and a polycondensation product of bisphenol A ethylene oxide (2 mol) adduct and isophthalic acid.

(9) a mixture of: a urea-modified polyester resin which is obtained by modifying, with hexamethylene diamine, polyester prepolymer which is obtained by reacting diphenylmethane diisocyanate with a polycondensation product of bisphenol A ethylene oxide (2 mol) adduct, bisphenol A propylene oxide (2 mol) adduct, terephthalic acid and dodecenylsuccinic anhydride; and a polycondensation product of bisphenol A ethylene oxide (2 mol) adduct, bisphenol A propylene oxide (2 mol) adduct and terephthalic acid.

(10) a mixture of: a urea-modified polyester resin which is obtained by modifying, with hexamethylene diamine, polyester prepolymer which is obtained by reacting toluene diisocyanate with a polycondensation product of bisphenol A ethylene oxide (2 mol) adduct and isophthalic acid; and a polycondensation product of bisphenol A ethylene oxide (2 mol) adduct and isophthalic acid.

The urea-modified polyester resin is not particularly limited and may be appropriately selected depending on the intended purpose, and is formed by, for example, the following methods.

(1) The solution or dispersion liquid of the toner material containing the polymer reactive with the active hydrogen group-containing compound (e.g., the isocyanate group-containing polyester prepolymer (A)) is emulsified or dispersed in the aqueous medium together with the active hydrogen group-containing compound (e.g., the amine (B)) so as to form oil droplets, and these two compounds are allowed to proceed the elongation reaction and/or crosslinking reaction in the aqueous medium.

(2) The solution or dispersion liquid is emulsified or dispersed in the aqueous medium, to which the active hydrogen group-containing compound has previously been added, so as to form oil droplets, and these two compounds are allowed to proceed the elongation reaction and/or crosslinking reaction in the aqueous medium.

(3) The solution or dispersion liquid is added and mixed in the aqueous medium, and then the active hydrogen group-containing compound is added thereto so as to form oil droplets, and these two compounds are allowed to proceed the elongation reaction and/or crosslinking reaction from the surfaces of the particles in the aqueous medium. In the case of (3), the modified polyester resin is preferentially formed at the surface of the toner to be formed, and thus the concentration gradation of the modified polyester resin can be provided within the toner particles.

The reaction conditions for forming the adhesive base material through emulsification or dispersion are not particularly limited and may be appropriately selected depending on the combination of the active hydrogen group-containing compound and the polymer reactive with the active hydrogen group-containing compound. The reaction time is preferably 10 minutes to 40 hours, more preferably 2 hours to 24 hours.

The method for stably forming the dispersion containing the polymer reactive with the active hydrogen group-containing compound (e.g., the isocyanate group-containing polyester prepolymer (A)) in the aqueous medium is such that the solution or dispersion liquid, which is prepared by dissolving or dispersing in the organic solvent the toner material containing the polymer reactive with the active hydrogen group-containing compound (e.g. the isocyanate group-containing polyester prepolymer (A)), the colorant, the releasing agent, the charge controlling agent, the unmodified polyester resin, and the like, is added to the aqueous medium, and then dispersed by shearing force.

In emulsification or dispersion, the amount of the aqueous medium used is not particularly limited and may be appropriately selected depending on the intended purpose. It is preferably 50 parts by mass to 2,000 parts by mass, more preferably 100 parts by mass to 1,000 parts by mass, relative to 100 parts by mass of the toner material. When the amount of the aqueous medium used is less than 50 parts by mass relative to 100 parts by mass of the toner material, the toner material is poorly dispersed, possibly failing to obtain toner particles having a predetermined particle diameter. When the amount of the aqueous medium used is more than 2,000 parts by mass, the production cost may increase.

The aqueous medium preferably contains anionic surfactants and styrene acrylic resin fine particles (an emulsion stabilizer), and further contains the following inorganic compound dispersants and polymer protective colloids in combination with the anionic surfactants and the styrene acrylic resin fine particles. The inorganic compound dispersants having sparing water solubility are not particularly limited and may be appropriately selected depending on the intended purpose. Examples thereof include tricalcium phosphate, calcium carbonate, titanium oxide, colloidal silica, and hydroxyapatite.

The polymer protective colloids are not particularly limited and may be appropriately selected depending on the intended purpose. Examples thereof include acids, (meth)acrylic monomers having a hydroxyl group, vinyl alcohols or ethers of vinyl alcohols, esters of vinyl alcohol and compounds having a carboxyl group, amide compounds or methylol compounds thereof, chlorides, homopolymers or copolymers of a compound containing a nitrogen atom or a nitrogen-containing heterocyclic ring, polyoxyethylene, and celluloses.

The acids are not particularly limited and may be appropriately selected depending on the intended purpose. Examples thereof include acrylic acid, methacrylic acid, α-cyanoacrylic acid, α-cyanomethacrylic acid, itaconic acid, crotonic acid, fumaric acid, maleic acid, and maleic anhydride.

The (meth)acrylic monomers having a hydroxyl group are not particularly limited and may be appropriately selected depending on the intended purpose. Examples thereof include β-hydroxyethyl acrylate, β-hydroxylethyl methacrylate, β-hydroxylpropyl acrylate, β-hydroxylpropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate, N-methylolacrylamide, and N-methylolmethacrylamide.

The vinyl alcohols or ethers of vinyl alcohols are not particularly limited and may be appropriately selected depending on the intended purpose. Examples of the vinyl alcohols or ethers of vinyl alcohols include vinyl methyl ether, vinyl ethyl ether, and vinyl propyl ether. The esters of vinyl alcohols and compounds having a carboxyl group are not particularly limited and may be appropriately selected depending on the intended purpose. Examples of the esters of vinyl alcohols and compounds having a carboxyl group include vinyl acetate, vinyl propionate, and vinyl butyrate. The amide compounds or methylol compounds thereof are not particularly limited and may be appropriately selected depending on the intended purpose. Examples of the amide compounds or methylol compounds thereof include acryl amide, methacryl amide, diacetone acryl amide acid, and methylol compounds thereof.

The chlorides are not particularly limited and may be appropriately selected depending on the intended purpose. Examples of the chlorides include acrylic acid chloride, and methacrylic acid chloride. The homopolymers or copolymers of a compound containing a nitrogen atom or a nitrogen-containing heterocyclic ring are not particularly limited and may be appropriately selected depending on the intended purpose. Examples of the homopolymers or copolymers of a compound containing a nitrogen atom or a nitrogen-containing heterocyclic ring include vinyl pyridine, vinyl pyrrolidone, vinyl imidazole, and ethylene imine.

The polyoxy ethylenes are not particularly limited and may be appropriately selected depending on the intended purpose. Examples of the polyoxy ethylenes include polyoxyethylene, polyoxypropylene, polyoxyethylene alkylamine, polyoxypropylene alkylamine, polyoxyethylene alkylamide, polyoxypropylene alkylamide, polyoxyethylene nonylphenylether, polyoxyethylene laurylphenylether, polyoxyethylene stearylphenylester, and polyoxyethylene nonylphenylester.

Celluloses are not particularly limited and may be appropriately selected depending on the intended purpose. Examples of the cellulose include methyl cellulose, hydroxyethyl cellulose, and hydroxypropyl cellulose.

When a dispersion stabilizer (e.g., calcium phosphate) soluble in an acid or alkalis is used, the calcium phosphate can be removed from fine particles by dissolving it with an acid such as hydrochloric acid, followed by washing with water; or by enzymatically decomposing it.

The binder resin exhibits adhesion to a recording medium such as paper, etc. and preferably contains an adhesive polymer obtained by allowing an active hydrogen group-containing compound and a polymer reactive with the active hydrogen group-containing compound to react in an aqueous medium.

### —Active Hydrogen Group-Containing Compound—

In the present invention, by incorporating in the toner material the active hydrogen group-containing compound and a modified polyester resin reactive with the active hydrogen group-containing compound, the mechanical strength of the resultant toner is increased and embedding of resin fine particles and external additives can be suppressed. When the active hydrogen group-containing compound has a cationic polarity, it can electrostatically pull the resin fine particles. Further, the fluidity of the toner during the heat fixation can be regulated, and, consequently, the fixing temperature range can be broadened. Notably, the active hydrogen group-containing compound and the modified polyester resin reactive with the active hydrogen group-containing compound can be said to be a binder resin precursor.

The active hydrogen group-containing compound serves, in the aqueous medium, as an elongating agent, a crosslinking agent, etc. for reactions of elongation, crosslinking, etc. of a polymer reactive with the active hydrogen group-containing compound. The active hydrogen group-containing compound is not particularly limited and may be appropriately selected depending on the intended purpose, as long as it contains an active hydrogen group. For example, when the polymer reactive with the active hydrogen group-containing compound is an isocyanate group-containing polyester prepolymer (A), an amine (B) is preferably used as the active hydrogen group-containing compound, since it can provide a high-molecular-weight product through reactions of elongation, crosslinking, etc. with the isocyanate group-containing polyester prepolymer (A).

The active hydrogen group is not particularly limited and may be appropriately selected depending on the intended purpose, as long as it contains an active hydrogen atom. Examples thereof include a hydroxyl group (alcoholic or phenolic hydroxyl group), an amino group, a carboxylic group and a mercapto group. These may be used alone or in combination.

The amine (B) is not particularly limited and may be appropriately selected depending on the intended purpose. Examples thereof include diamines (B1), trivalent or higher polyamines (B2), amino alcohols (B3), aminomercaptans (B4), amino acids (B5), and amino-blocked products (B6) of the amines (B1) to (B5). These may be used alone or in combination. Among these, preferred are diamines (B1) and a mixture of the diamines (B1) and a small amount of the trivalent or higher polyamines (B2).

Examples of the diamines (B1) include aromatic diamines, alicyclic diamines and aliphatic diamines. Examples of the aromatic diamines include phenylenediamine, diethyltoluenediamine and 4,4′-diaminodiphenylmethane. Examples of the alicyclic diamines include 4,4′-diamino-3,3′-dimethyldicyclohexylmethane, diaminecyclohexane and isophoronediamine. Examples of the aliphatic diamines include ethylenediamine, tetramethylenediamine and hexamethylenediamine.

Examples of the trivalent or higher polyamines (B2) include diethylenetriamine and triethylenetetramine. Examples of the amino alcohols (B3) include ethanolamine and hydroxyethylaniline. Examples of the aminomercaptans (B4) include aminoethyl mercaptan and aminopropyl mercaptan. Examples of the amino acids (B5) include aminopropionic acid and aminocaproic acid.

Examples of the amino-blocked products (B6) include ketimine compounds and oxazolidine compounds derived from the amines (B1) to (B5) and ketones (e.g., acetone, methyl ethyl ketone and methyl isobutyl ketone).

Also, a reaction terminator is used for terminating elongation reaction, etc. crosslinking reaction between the active hydrogen group-containing compound and the polymer reactive therewith. Use of the reaction terminator can control the adhesive base material in its molecular weight, etc. to a desired range. The reaction terminator is not particularly limited, and examples thereof include monoamines (e.g., diethyl amine, dibutyl amine, butyl amine and lauryl amine) and blocked products thereof (e.g., ketimine compounds).

The mixing ratio of the isocyanate group-containing polyester prepolymer (A) to the amine (B) is not particularly limited but preferably 1/3 to 3/1, more preferably 1/2 to 2/1, particularly preferably 1/1.5 to 1.5/1, in terms of the equivalent ratio ([NCO]/[NHx]) of the isocyanate group [NCO] in the isocyanate group-containing prepolymer (A) to the amino group [NHx] in the amine (B). When the equivalent ratio ([NCO]/[NHx]) is less than ⅓, the formed toner may have degraded low-temperature fixing ability. When the equivalent ratio ([NCO]/[NHx]) is more than 3/1, the molecular weight of the urea-modified polyester resin decreases, resulting in that the formed toner may have degraded hot offset resistance.

—Polymer Reactive with Active Hydrogen Group-Containing Compound—

The polymer reactive with the active hydrogen group-containing compound (hereinafter also referred to as a “prepolymer”) is not particularly limited and may be appropriately selected from known resins depending on the intended purpose, as long as it has at least a site reactive with the active hydrogen group-containing compound. Examples thereof include polyol resins, polyacrylic resins, polyester resins, epoxy resins, and derivative resins thereof. These may be used alone or in combination. Of these, polyester resins are preferred since they have high fluidity upon melting and high transparency.

In the prepolymer, the reaction site reactive with the active hydrogen group-containing group is not particularly limited and may be appropriately selected from known substituents (moieties). Examples thereof include an isocyanate group, an epoxy group, a carboxyl group and an acid chloride group. These may be used alone or in combination as the reaction site. Of these, an isocyanate group is particularly preferred. As the prepolymer, a urea bond-forming group-containing polyester resin (RMPE) containing a urea bond-forming group is preferred, since it is easily adjusted for the molecular weight of the polymeric component thereof and thus is preferably used for forming dry toner, in particular for assuring oil-less low temperature fixing ability (e.g., releasing and fixing properties requiring no releasing oil-application mechanism for a heating medium for fixation).

Examples of the urea bond-forming group include an isocyanate group. Preferred examples of the RMPE having an isocyanate group as the urea bond-forming group include the isocyanate group-containing polyester prepolymer (A). The isocyanate group-containing polyester prepolymer (A) is not particularly limited and may be appropriately selected depending on the intended purpose. Examples thereof include those produced as follows: a polyol (PO) is polycondensed with a polycarboxylic acid (PC) to form an active hydrogen group-containing polyester; and the thus-formed polyester is reacted with a polyisocyanate (PIC). The polyol (PO) is not particularly limited and may be appropriately selected depending on the intended purpose. Examples thereof include diols (DIOs), trihydric or higher polyols (TOs), and mixtures of diols (DIOs) and trihydric or higher polyols (TOs). These may be used alone or in combination. Of these, preferred are diols (DIOs) and mixtures of diols (DIOs) and a small amount of trihydric or higher polyols (TOs).

Examples of the diol (DIO) include alkylene glycols, alkylene ether glycols, alicyclic diols, alkylene oxide adducts of alicyclic diols, bisphenols, and alkylene oxide adducts of bisphenols.

The alkylene glycols are preferably those having 2 to 12 carbon atoms, and examples thereof include ethylene glycol, 1,2-propylene glycol, 1,3-propylene glycol, 1,4-butanediol and 1,6-hexanediol. Examples of the alkylene ether glycols include diethylene glycol, triethylene glycol, dipropylene glycol, polyethylene glycol, polypropylene glycol and polytetramethylene ether glycol. Examples of the alicyclic diols include 1,4-cyclohexane dimethanol and hydrogenated bisphenol A. Examples of the alkylene oxide adducts of alicyclic diols include adducts of the alicyclic diols with alkylene oxides (e.g., ethylene oxide, propylene oxide and butylene oxide). Examples of the bisphenols include bisphenol A, bisphenol F and bisphenol S. Examples of the alkylene oxide adducts of bisphenols include adducts of the bisphenols with alkylene oxides (e.g., ethylene oxide, propylene oxide and butylene oxide). Of these, preferred are alkylene glycols having 2 to 12 carbon atoms and alkylene oxide adducts of bisphenols, particularly preferred are alkylene oxide adducts of bisphenols, and mixtures of alkylene glycols having 2 to 12 carbon atoms and alkylene oxide adducts of bisphenols.

As the trihydric or higher polyol (TO) tri- to octa-hydric polyols are preferably used. Examples thereof include trihydric or higher aliphatic alcohols, and trihydric or higher polyphenols, and alkylene oxide adducts of the trihydric or higher polyphenols. Examples of the trihydric or higher aliphatic alcohols include glycerin, trimethylolethane, trimethylolpropane, pentaerythritol and sorbitol. Examples of the trihydric or higher polyphenols include trisphenol compounds (e.g., trisphenol PA, manufactured by HONSHU CHEMICAL INDUSTRY CO., LTD.), phenol novolak and cresol novolak. Examples of the alkylene oxide adducts of the trihydric or higher polyphenols include adducts of the trihydric or higher polyphenols with alkylene oxides (e.g., ethylene oxide, propylene oxide and butylene oxide).

In the mixture of the diol (DIO) and the trihydric or higher polyol (TO), the mixing ratio by mass (DIO/TO) is preferably 100/0.01 to 100/10, more preferably 100/0.01 to 100/1.

The polycarboxylic acid (PC) is not particularly limited and may be appropriately selected depending on the intended purpose. Examples thereof include dicarboxylic acids (DICs), tri- or higher polycarboxylic acids (TCs), and mixtures of dicarboxylic acids (DICs) and the tri- or higher polycarboxylic acids (TCs). These may be used alone or in combination. Of these, preferred are dicarboxylic acids (DICs) and mixtures of DICs and a small amount of tri- or higher polycarboxylic acids (TCs).

Examples of the dicarboxylic acid (DIC) include alkylene dicarboxylic acids, alkenylene dicarboxylic acids, and aromatic dicarboxylic acids. Examples of the alkylene dicarboxylic acid include succinic acid, adipic acid and sebacic acid. The alkenylene dicarboxylic acid is preferably those having 4 to 20 carbon atoms, and examples thereof include maleic acid and fumaric acid. The aromatic dicarboxylic acid is preferably those having 8 to 20 carbon atoms, and examples thereof include phthalic acid, isophthalic acid, terephthalic acid, and naphthalenedicarboxylic acid. Of these, preferred are alkenylene dicarboxylic acids having 4 to 20 carbon atoms and aromatic dicarboxylic acids having 8 to 20 carbon atoms.

As the tri- or higher polycarboxylic acid (TC), tri- to octa-carboxylic acids (TC) are preferable. Examples of the tri- or higher polycarboxylic acid (TC) include aromatic polycarboxylic acids. The aromatic polycarboxylic acid is preferably those having 9 to 20 carbon atoms, and examples thereof include trimellitic acid and pyromellitic acid.

As the polycarboxylic acid (PC), there may be used acid anhydrides or lower alkyl esters of the dicarboxylic acids (DICs), the tri- or higher polycarboxylic acids (TCs), or mixtures of the dicarboxylic acids (DICs) and the tri- or higher polycarboxylic acids (TCs). Examples of the lower alkyl esters thereof include methyl esters thereof, ethyl esters thereof and isopropyl esters thereof.

In the mixture of the dicarboxylic acid (DIC) and the tri- or higher polycarboxylic acid (TC), the mixing ratio by mass (DIC/TC) is not particularly limited and may be appropriately selected depending on the intended purpose. Preferably, the mixing ratio (DIC/TC) is 100/0.01 to 100/10, more preferably 100/0.01 to 100/1.

In polycondensation reaction between the polyol (PO) and the polycarboxylic acid (PC), the mixing ratio of PO to PC is not particularly limited and may be appropriately selected depending on the intended purpose. The mixing ratio PO/PC is preferably 2/1 to 1/1, more preferably 1.5/1 to 1/1, particularly preferably 1.3/1 to 1.02/1, in terms of the equivalent ratio ([OH]/[COOH]) of hydroxyl group [OH] in the polyol (PO) to carboxyl group [COOH] in the polycarboxylic acid (PC).

The content of the polyol (PO) in the isocyanate group-containing polyester prepolymer (A) is not particularly limited and may be appropriately selected depending on the intended purpose. For example, it is preferably 0.5% by mass to 40% by mass, more preferably 1% by mass to 30% by mass, particularly preferably 2% by mass to 20% by mass. When the content of the polyol (PO) is less than 0.5% by mass, the formed toner has degraded hot offset resistance, making it difficult for the toner to attain both desired heat-resistant storage stability and desired low-temperature fixing ability. When the content of the polyol (PO) is more than 40% by mass, the formed toner may have degraded low-temperature fixing ability.

The polyisocyanate (PIC) is not particularly limited and may be appropriately selected depending on the intended purpose. Examples thereof include aliphatic polyisocyanates, alicyclic polyisocyanates, aromatic diisocyanates, aromatic/aliphatic diisocyanates, isocyanurates, phenol derivatives thereof, and blocked products thereof with oxime, caprolactam, etc.

Examples of the aliphatic polyisocyanates include tetramethylene diisocyanate, hexamethylene diisocyanate, 2,6-diisocyanatomethylcaproate, octamethylene diisocyanate, decamethylene diisocyanate, dodecamethylene diisocyanate, tetradecamethylene diisocyanate, trimethylhexane diisocyanate, and tetramethylhexane diisocyanate. Examples of the alicyclic polyisocyanates include isophorone diisocyanate and cyclohexylmethane diisocyanate. Examples of the aromatic diisocyanates include tolylene diisocyanate, diphenylmethane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate and diphenylether-4,4′-diisocyanate. Examples of the aromatic/aliphatic diisocyanates include α,α,α′,α′-tetramethylxylylene diisocyanate. Examples of the isocyanurates include tris-isocyanatoalkyl-isocyanurate and triisocyanatocycloalkyl-isocyanurate. These may be used alone or in combination.

In reaction between the polyisocyanate (PIC) and the polyester resin having an active hydrogen group (e.g., hydroxyl group-containing polyester resin), the ratio of the PIC to the hydroxyl group-containing polyester resin is preferably 5/1 to 1/1, more preferably 4/1 to 1.2/1, particularly preferably 3/1 to 1.5/1, in terms of the mixing equivalent ratio ([NCO]/[OH]) of an isocyanate group [NCO] in the polyisocyanate (PIC) to a hydroxyl group [OH] in the hydroxyl group-containing polyester resin. When the [NCO] in the mixing equivalent ratio [NCO]/[OH] is more than 5, the formed toner may have degraded low-temperature fixing ability. When the [NCO] in the mixing equivalent ratio [NCO]/[OH] is less than 1, the formed toner may have degraded offset resistance.

The content of the polyisocyanate (PIC) in the isocyanate group-containing polyester prepolymer (A) is not particularly limited and may be appropriately selected depending on the intended purpose. For example, it is preferably 0.5% by mass to 40% by mass, more preferably 1% by mass to 30% by mass, still more preferably 2% by mass to 20% by mass. When the content of the polyisocyanate (PIC) is less than 0.5% by mass, the formed toner may have degraded hot offset resistance, making it difficult for the toner to attain both a desired heat-resistant storage stability and a desired low-temperature fixing ability. When the content of the polyisocyanate (PIC) is more than 40% by mass, the formed toner may have degraded low-temperature fixing ability.

The average number of isocyanate groups per molecule of the isocyanate group-containing polyester prepolymer (A) is not particularly limited but is preferably one or more, more preferably 1.2 to 5, still more preferably 1.5 to 4. When the average number of the isocyanate groups is less than one per one molecule, the molecular weight of the polyester resin modified with a urea bond-forming group (RMPE) decreases, and the formed toner may have degraded hot offset resistance.

The weight average molecular weight (Mw) of the polymer reactive with the active hydrogen group-containing compound is not particularly limited but is preferably 3,000 to 40,000, more preferably 4,000 to 30,000 based on the molecular weight distribution obtained by analyzing tetrahydrofuran (THF) soluble matter of the polymer through gel permeation chromatography (GPC). When the weight average molecular weight (Mw) is lower than 3,000, the formed toner may have degraded heat-resistant storage stability. When the Mw is higher than 40,000, the formed toner may have degraded low-temperature fixing ability.

### —Colorant—

The colorant is not particularly limited and may be appropriately selected from known dyes and pigments depending on the intended purpose. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower and lithopone. These colorants may be used alone or in combination.

The amount of the colorant contained in the toner is not particularly limited and may be appropriately determined depending on the intended purpose. It is preferably 1% by mass to 15% by mass, more preferably 3% by mass to 10% by mass. When the amount of the colorant is less than 1% by mass, the formed toner may degrade in coloring performance. When the amount is more than 15% by mass, the pigment is not sufficiently dispersed in the toner, possibly causing decrease in coloring performance and in electrical properties of the formed toner.

The colorant may be mixed with a resin to form a masterbatch. The resin is not particularly limited and may be appropriately selected from those known in the art. Examples thereof include polyesters, polymers of styrene or substituted styrene, styrene copolymers, polymethyl methacrylates, polybutyl methacrylates, polyvinyl chlorides, polyvinyl acetates, polyethylenes, polypropylenes, epoxy resins, epoxy polyol resins, polyurethanes, polyamides, polyvinyl butyrals, polyacrylic acid resins, rosin, modified rosins, terpene resins, aliphatic or alicyclic hydrocarbon resins, aromatic petroleum resins, chlorinated paraffins and paraffin waxes. These resins may be used alone or in combination.

Examples of the polymers of styrene or substituted styrene include polyesters, polystyrenes, poly(p-chlorostyrenes) and polyvinyltoluenes. Examples of the styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers.

The masterbatch can be prepared by mixing or kneading a colorant with the resin for use in the masterbatch through application of high shearing force. Preferably, an organic solvent may be used for improving the interactions between the colorant and the resin. Further, a so-called flashing method is preferably used, since a wet cake of the colorant can be directly used, i.e., no drying is required. Here, the flashing method is a method in which an aqueous paste containing a colorant is mixed or kneaded with a resin and an organic solvent, and then the colorant is transferred to the resin to remove the water and the organic solvent. In this mixing or kneading, for example, a high-shearing disperser (e.g., a three-roll mill) is preferably used. The colorant may be incorporated into any of a first resin phase and a second resin phase by utilizing the difference in affinity to the two resins. As has been known well, when exists in the surface of the toner, the colorant degrades charging performance of the toner. Thus, by selectively incorporating the colorant into the first resin phase which is the inner layer, the formed toner can be improved in charging performances (e.g., environmental stability, charge retainability and charging amount).

### —Releasing Agent—

The releasing agent is not particularly limited and may be appropriately selected depending on the intended purpose. The melting point thereof is preferably low; i.e., 50° C. to 120° C. When dispersed together with a resin, such a low-melting-point releasing agent effectively exhibits its releasing effects on the interface between a fixing roller and each toner particle. Thus, even when an oil-less mechanism is employed (in which a releasing agent such as oil is not applied onto a fixing roller), excellent hot offset resistance is attained.

Preferred examples of the releasing agent include waxes. Examples of the waxes include natural waxes such as vegetable waxes (e.g., carnauba wax, cotton wax, Japan wax and rice wax), animal waxes (e.g., bees wax and lanolin), mineral waxes (e.g., ozokelite and ceresine) and petroleum waxes (e.g., paraffin waxes, microcrystalline waxes and petrolatum); synthetic hydrocarbon waxes (e.g., Fischer-Tropsch waxes and polyethylene waxes); and synthetic waxes (e.g., ester waxes, ketone waxes and ether waxes). Further examples include fatty acid amides such as 12-hydroxystearic acid amide, stearic amide, phthalic anhydride imide and chlorinated hydrocarbons; low-molecular-weight crystalline polymer resins such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain. These releasing agents may be used alone or in combination.

The melting point of the releasing agent is not particularly limited and may be appropriately selected depending on the intended purpose. The melting point is preferably 50° C. to 120° C., more preferably 60° C. to 90° C. When the melting point is lower than 50° C., the wax may adversely affect the heat-resistant storage stability of the toner. When the melting point is higher than 120° C., cold offset is easily caused upon fixing at lower temperatures. The melt viscosity of the releasing agent is not particularly limited and may be appropriately selected depending on the intended purpose. In the case where the melt viscosity of the releasing agent is measured at the temperature 20° C. higher than the melting point of the wax, it is preferably 5 cps to 1,000 cps, more preferably 10 cps to 100 cps. When the melt viscosity is lower than 5 cps, the formed toner may degrade in releasing ability. When the melt viscosity is higher than 1,000 cps, the hot offset resistance and the low-temperature fixing ability may not be improved. The amount of the releasing agent contained in the toner is not particularly limited and may be appropriately selected depending on the intended purpose. The amount of the releasing agent is preferably 40% by mass or less, more preferably 3% by mass to 30% by mass. When the amount is higher than 40% by mass, the formed toner may be degraded in flowability.

The releasing agent may be incorporated into any of the first resin phase and the second resin phase by utilizing the difference in affinity to the two resins. By selectively incorporating the releasing agent into the second resin phase which is the outer layer of the toner, the releasing agent oozes out satisfactorily in a short heating time in the fixation and, consequently, satisfactory releasability can be realized. On the other hand, by selectively incorporating the releasing agent into the first resin phase which is the inner layer, the spent of the releasing agent to other members such as the photoconductors and carriers can be suppressed. In the present invention, the arrangement of the releasing agent is sometimes freely designed and the releasing agent may be arbitrarily arranged according to various image forming processes.

### —Charge Controlling Agent—

The charge controlling agent is not particularly limited and may be appropriately selected from those known in the art. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based active agents, metal salts of salicylic acid, and metal salts of salicylic acid derivatives. These may be used alone or in combination.

Also, the charge controlling agent may be a commercially available product. The commercially available product may be, for example, resins or compounds each having an electron-donating property, azo dyes and metal complexes of organic acids. Examples thereof include nigrosine dye BONTRON 03, quaternary ammonium salt BONTRON P-51, metal azo-containing dye BONTRON S-34, oxynaphthoic acid-based metal complex E-82, salicylic acid-based metal complex E-84 and phenol condensate E-89 (manufactured by ORIENT CHEMICAL INDUSTRIES CO., LTD); metal complex of salicylic acid TN-105, quaternary ammonium salt molybdenum complex TP-302 and TP-415 (manufactured by Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (manufactured by Hoechst AG); boron complex LRA-901 and LR-147 (manufactured by Japan Carlit Co., Ltd.); copper phthalocyanine; perylene; quinacridone; azo pigments; and polymeric compounds having, as a functional group, a sulfonic acid group, carboxyl group, quaternary ammonium salt, etc.

The charge controlling agent may be incorporated into a resin phase inside the toner base particles by utilizing the difference in affinity to the resin in the toner base particles. By selectively incorporating the charge controlling agent into the resin phase inside the toner base particles present in the inner layer, the spent of the charge controlling agent to other members such as the photoconductors and carriers can be suppressed. In the method for producing a toner of the present invention, the arrangement of the charge controlling agent may be freely designed and the charge controlling agent may be arbitrarily arranged according to various image forming processes.

### <Emulsion or Dispersion Liquid Preparing Step>

The emulsion or dispersion liquid preparing step is a step of emulsifying or dispersing the solution or dispersion liquid in an aqueous medium containing at least acrylic resin fine particles, so as to prepare an emulsion or dispersion liquid. The aqueous medium may contain other components such as resin fine particles.

### —Acrylic Resin Fine Particles—

The acrylic resin fine particles are not particularly limited and may be appropriately selected depending on the intended purpose. The acrylic resin fine particles are preferably crosslinked polymers, more preferably the acrylic resin fine particles copolymerized with a monomer having at least two unsaturated groups, in order for the acrylic resin fine particles to be fixed onto a surface of an emulsified droplet, rather than being dissolved, when the acrylic resin fine particles adhere to the emulsified droplet.

The monomer having at least two unsaturated groups is not particularly limited and may be appropriately selected depending on the intended purpose. Examples thereof include sodium salt of sulfuric acid ester of ethylene oxide adduct of methacrylic acid, ELEMINOL RS-30 (manufactured by Sanyo Chemical Industries Ltd.), divinyl compounds such as divinylbenzene, and diacrylate compounds such as 1,6-hexanediol diacrylate.

The resin component in the acrylic resin fine particles is not particularly limited and may be appropriately selected depending on the intended purpose. It is preferably a styrene acrylic resin incompatible with a resin contained in the toner. Examples thereof include styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, and styrene-acrylonitrile-indene copolymers. Moreover, the resin component in the acrylic resin fine particles may be copolymers of styrene and the other resin. Examples thereof include styrene-p-chlorostyrene copolymers, styrene-propylene copolymers, styrene-vinyltoluene copolymers, styrene-vinylnaphthalene copolymers, styrene-vinyl methyl ketone copolymers, styrene-butadiene copolymers, styrene-isoprene copolymers, styrene-maleic acid copolymers and styrene-maleic acid ester copolymers.

The acrylic resin fine particles having properties that they are unstable and form aggregates upon mixing them with an anionic surfactant solution, easily adhere to a surface of a droplet of the toner material. In order to attain such properties, the acrylic resin fine particles are produced by using nonionic surfactants, ampholytic surfactants, and cationic surfactants, or introducing into a resin a cationic group, such as an amine group, an ammonium salt group, etc.

The acrylic resin fine particles are preferably localized near a surface of a toner in the form of particles, so as to form a layer of particles. In the present invention, “near a surface of a toner” means 1 nm to 100 nm from the surface of the toner.

The acrylic resin fine particles are preferably localized near a surface of a toner and inside the toner in the form of particles, so as to form a layer of particles. A wax as a toner component exists inside the toner in the form of another phase before fixation, i.e., while being separated from the resin inside the toner. When such component is exposed on the outermost surface of the toner, problems occur such as impairing toner fluidity, contamination of other members, and increase in non-electrostatic adhesive force between the toner and the member, causing difficulty in transferring. It is effective in solving the above-mentioned problems by forming a shell on a toner for separating the toner from outside so as to form the toner having a core-shell structure. However, by forming a uniform shell layer, the components inside the shell layer are hard to be exposed on the shell upon fixation, and cannot exhibit their functions. For example, a resin is softened by heat and the effect of a fixing aid, but the shell layer prevents the resin from being brought into contact with paper. Moreover, the shell prevents a wax responsible for releasing effect from oozing out to the outside of the toner.

In the present invention, a surface of a toner base particle (colorant particle) is formed of a layer of crosslinked resin fine particles such as acrylic resin fine particles. The layer of the crosslinked resin is preferably formed of crosslinked resin fine particles such as acrylic resin fine particles, and in the form of particle aggregates. The particle aggregates can be observed with a transmission electron microscope, and the particle aggregates form at least one layer, preferably two to five layers on the surface of the toner base particle. Suitable crosslinking degree of the crosslinked resin fine particles such as the acrylic resin fine particles, and amount added thereof depending on the particle size are necessary to form a structure of the toner base particle.

The range of Tg of the acrylic resin fine particles is not particularly limited and may be appropriately selected depending on the intended purpose. It is preferably 60° C. to 100° C. By adjusting the glass transition temperature to the above range, the surface of the toner can be protected without inhibiting fixation.

The volume average particle diameter of each acrylic resin fine particle is not particularly limited and may be appropriately selected depending on the intended purpose. It is preferably 20 nm to 200 nm, more preferably 40 nm to 100 nm, particularly preferably 50 nm to 100 nm. When the volume average particle diameter is small, the surface of the toner base particle can be coated with a small amount of the acrylic resin fine particles, but the thickness of a layer to be formed becomes excessively thin. On the other hand, when the volume average particle diameter is large, the large amount of the acrylic resin fine particles is required, and fixation inhibiting effect becomes large.

The volume average particle diameter of the acrylic resin fine particles can be measured by, for example, SEM, TEM or a light scattering method. Specifically, using a particle size distribution analyzer LA-920 (manufactured by HORIBA, Ltd.) based on a laser scattering method, the acrylic resin fine particles are diluted to a proper concentration at which the measured value falls within the measurement range, followed by measuring a particle diameter.

The molecular weight of the acrylic resin fine particles is not particularly limited and may be appropriately selected depending on the intended purpose. It is preferably, as a weight average molecular weight, 10,000 to 200,000, more preferably 15,000 to 100,000. When the weight average molecular weight is less than 10,000, the acrylic resin fine particles dissolve into ethyl acetate, and form no layer, possibly failing to obtain heat resistant storage stability and sufficient mechanical strength. When the weight average molecular weight is more than 200,000, the melt viscosity of the toner surface increases, possibly adversely affecting the low temperature fixing ability.

The molecular weight of the acrylic resin fine particles can be measured by gel permeation chromatography (GPC).

The crosslinking degree of the acrylic resin fine particles is not particularly limited and may be appropriately selected depending on the intended purpose. It is preferably 10% to 80%, more preferably 30% to 60%. When the crosslinking degree is less than 10%, even when the acrylic resin fine particles adhere to the surface of the toner, they are dissolved and absorbed inside the toner, failing to uniformly locate on the surface of the toner. When the crosslinking degree is more than 80%, the fine particles exist on the surface of the toner in the form of particles, but swellability and adhesion of the fine particles are low, a layer of the fine particles on the toner surface has a weak strength, and is separated from the surface of the toner particle, causing losing of the surface protection function, and contamination of members to be in contact therewith.

By adjusting the crosslinking degree to the above-described range, the acrylic resin fine particles can remain as particles on the surface of the toner particle, and adequately blended in a resin contained in the toner.

The crosslinking degree can be obtained in such a manner that a resin is immersed in a solvent for a time necessary for the solvent to swell and dissolve in the resin, and then taken out from the solvent, and a mass of the resin is measured, followed by drying, and measuring the mass of the resin remaining after drying.

The crosslinking degree can be determined by the following method. Inside an extraction thimble in a Soxhlet extractor, 3 g of dried resin fine particles are placed, and then boiled for 12 hours and reflux extracted using ethyl acetate, to thereby extract a soluble matter. The residual insoluble matter is dried and precisely weighed, to thereby obtain the crosslinking degree (%) of the residue.

Next, a method of locating the crosslinked resin fine particles on the surface of the toner will be described. When toner particles are formed in water, in the case where the charge on the fine particle surface is different from the charge on the toner surface in terms of amount and state (positive or negative), so-called heteroaggregation caused by electrostatic attraction easily occurs, and fine particles uniformly aggregate on the surface of the toner and easily adhere thereonto. The fine particles need to be incorporated into the resin layer which is a surface layer of the toner, in order to achieve that the fine particles not only adhere to the toner surface, but also form the structure of the present invention, that is, the fine particles form the outermost surface layer of the toner and physical force prevents the outermost surface layer from being separated from the toner surface. At that time, an important factor is the affinity of the fine particles with an oil droplet of a toner precursor containing an organic solvent, a polymerizable monomer and a toner constituting resin in water. When the affinity to the aqueous phase is high, the fine particles remain on the toner surface and do not fix inside the toner. When the affinity to the oil droplet is excessively high, the fine particles enter inside a toner and do not locate near the toner surface. In order to control such properties, it is necessary to adjust polarities of the fine particles and resin, and a polarity of the surface of each of the fine particles to neutral. Such properties are influenced by selection of a functional group of the resin, a surfactant used for production of the fine particles. However, when fine particles are fixed on a toner surface layer, the fine particles are crosslinked and exist in the form of particles in the toner surface layer, so as not to dissolve the fine particles in a toner precursor which is formed of the organic solvent, the polymerizable monomer, and the toner constituting resin.

### —Cationic Surfactant—

The cationic surfactants are not particularly limited and may be appropriately selected depending on the intended purpose. Examples thereof include amine salts, and quaternary ammonium salts. Examples of the amine salts include alkyl amine salts, amino alcohol fatty acid derivatives, polyamine fatty acid derivatives, and imidazoline. Examples of the quaternary ammonium salts include alkyltrimethyl ammonium salts, dialkyldimethyl ammonium salts, alkyldimethyl benzyl ammonium salts, pyridinium salts, alkyl isoquinolinium salts, and benzethonium chloride. These may be used alone or in combination.

Of these, preferable examples thereof include primary, secondary or tertiary fluoroalkyl group-containing aliphatic amine acids, aliphatic quaternary ammonium salts such as perfluoroalkyl(C6-C10) sulfoneamide propyl trimethyl ammonium salts, benzalkonium salts, benzetonium chloride, pyridinium salts, and imidazolinium salt.

The commercially available products of the cationic surfactants are not particularly limited and may be appropriately selected depending on the intended purpose. Examples thereof include, but not limited to, SURFLON S-121 (manufactured by Asahi Glass Co., Ltd.), FLUORAD FC-135 (manufactured by Sumitomo 3M Limited), UNIDYNE DS-202 (manufactured by Daikin Industries, Ltd.), MEGAFACE F-150 and F-824 (manufactured by Dainippon Ink and Chemicals, Incorporated), EFTOP EF-132 (manufactured by Tohchem Products Co., Ltd.), and FTERGENT F-300 (manufactured by NEOS COMPANY LIMITED).

### —Nonionic Surfactant—

The nonionic surfactants are not particularly limited and may be appropriately selected depending on the intended purpose. Examples thereof include fatty acid amide derivatives, and polyhydric alcohol derivatives.

### —Ampholytic Surfactant—

The ampholytic surfactants are not particularly limited and may be appropriately selected depending on the intended purpose. Examples thereof include alanine, dodecyldi(aminoethyl)glycine, di(octylaminoethyl)glycine, and N-alkyl-N,N-dimethyl ammonium betaine.

### —Aqueous Medium—

The aqueous medium is not particularly limited and may be appropriately selected from those known in the art, as long as it contains the acrylic resin fine particles. Examples thereof include water, water-miscible solvents and mixtures thereof. Of these, water is particularly preferred.

The water miscible solvent is not particularly limited, as long as it is miscible with water. Examples thereof include alcohols, dimethylformamide, tetrahydrofuran, cellsolves and lower ketones. Examples of the alcohols include methanol, isopropanol and ethylene glycol. Examples of the lower ketones include acetone and methyl ethyl ketone. These may be used alone or in combination.

The preparation of the aqueous medium can be performed by dispersing the resin fine particles in the aqueous medium in the presence of an anionic surfactant. The amounts added of the anionic surfactant and the resin fine particles in the aqueous medium are not particularly limited and may be appropriately selected depending on the intended purpose. For example, the amounts added of the anionic surfactant and the resin fine particles are preferably respectively 0.5% by mass to 10% by mass.

### —Emulsification or Dispersion—

The emulsification or dispersion of the solution or dispersion liquid in the aqueous medium is preferably performed by dispersing the solution or dispersion liquid in the aqueous medium with stirring. The dispersion method is not particularly limited and may be appropriately selected depending on the intended purpose. For example, known dispersers may be used for dispersion. The dispersers are not particularly limited, and examples thereof include low-speed shear dispersers and high-speed shear dispersers. In the method for producing a toner, during the emulsification or dispersion, the active hydrogen group-containing compound and the polymer reactive with the active hydrogen group-containing compound are subjected to elongation reaction or crosslinking reaction, to thereby form an adhesive base material.

The resin fine particles may be added in the aqueous medium during or after emulsification. The resin fine particles are added either by dispersing using the high-speed shear disperser or after emulsification or dispersion by the low-speed shear disperser switched from the high-speed shear disperser, while observing adhesion or fixation state of the resin particles to the toner.

### —Resin Fine Particles—

A resin used as the resin fine particles is not particularly limited as long as the resin can form an aqueous dispersion liquid in the aqueous medium, and may be appropriately selected from known resins depending on the intended purpose. The resin used as the resin fine particles may be a thermoplastic or thermosetting resin. Examples thereof include vinyl resins, polyurethane resins, epoxy resins, polyester resins, polyamide resins, polyimide resins, silicon resins, phenol resins, melamine resins, urea resins, aniline resins, ionomer resins and polycarbonate resins. These may be used alone or in combination. Among these, at least one selected from vinyl resins, polyurethane resins, epoxy resins and polyester resins is preferable, from the viewpoint of easy preparation of an aqueous dispersion liquid containing spherical resin fine particles.

The vinyl resin is a homopolymer or copolymer of a vinyl monomer. Examples thereof include styrene-(meth)acrylate ester resins, styrene-butadiene copolymers, (meth)acrylic acid-acrylate ester polymers, styrene-acrylonitrile copolymers, styrene-maleic anhydride copolymers and styrene-(meth)acrylic acid copolymers.

The resin fine particles must be anionic to avoid aggregation when used in combination with the above-described anionic surfactant. The resin fine particles can be prepared by using an anionic active agent in the below-described methods or by introducing into a resin an anionic group such as a carboxylic acid group and/or a sulfonic acid group.

As the particle diameter of each resin fine particle, the average particle diameter of the primary particles is 5 nm to 50 nm. This is important for regulating the particle diameter and the particle size distribution of the emulsified particles. It is more preferably 10 nm to 25 nm.

The average particle diameter of the resin fine particles can be measured by, for example, SEM, TEM or a light scattering method. Preferably, using a particle size distribution analyzer, LA-920 (manufactured by HORIBA, Ltd.) based on a laser scattering method, the resin fine particles are diluted to a proper concentration at which the measured value falls within the measurement range, and then measured. The particle diameter is determined as a volume average diameter.

The method of preparing the resin fine particles is not particularly limited, and the resin fine particles can be obtained by polymerization according to the known method appropriately selected depending on the intended purpose. The resin fine particles are preferably obtained in the form of an aqueous dispersion liquid of the resin fine particles. The method of preparing the aqueous dispersion liquid of resin fine particles is preferably as follows, for example:

(1) in the case of vinyl resins, a method in which an aqueous dispersion liquid of the resin fine particles is directly produced by subjecting a vinyl monomer serving as a starting material to polymerization reaction by any one of a suspension polymerization method, an emulsification polymerization method, a seed polymerization method and a dispersion polymerization method;

(2) in the case of polyadded or condensed resins such as polyester resins, polyurethane resins and epoxy resins, a method in which an aqueous dispersion liquid of fine particles of the polyadded or condensed resins is produced by dispersing their precursor (e.g., monomer or oligomer) or a solution thereof in an aqueous medium in the presence of an appropriate dispersant and then curing the resultant dispersion with heating or through addition of a curing agent;

(3) in the case of polyadded or condensed resins such as polyester resins, polyurethane resins and epoxy resins, a method in which an aqueous dispersion of fine particles of the polyadded or condensed resins is produced by dissolving an appropriate emulsifier in their precursor (e.g., monomer or oligomer) or a solution thereof (which is preferably a liquid or may be liquefied with heating) and then adding water to the resultant mixture for phase inversion emulsification;

(4) a method in which a resin is prepared through polymerization reaction (e.g., addition polymerization, ring-opening polymerization, polyaddition, addition condensation or condensation polymerization); the thus-prepared resin is pulverized using a mechanically rotary pulverizer, a jet pulverizer, etc., and then classified; and the thus-formed resin fine particles are dispersed in water in the presence of an appropriate dispersant;

(5) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; the thus-prepared resin solution is sprayed to produce resin fine particles; and the thus-produced resin fine particles are dispersed in water in the presence of an appropriate dispersant;

(6) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution, followed by addition of a poor solvent for precipitation, or the thus-prepared resin is dissolved with heating in a solvent to prepare a resin solution, followed by cooling for precipitation; the solvent is removed to produce resin fine particles; and the thus-produced resin fine particles are dispersed in water in the presence of an appropriate dispersant;

(7) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; the thus-prepared resin solution is dispersed in an aqueous medium in the presence of an appropriate dispersant; and the solvent is removed with heating or under reduced pressure; and

(8) a method in which a resin is prepared through polymerization reaction (e.g., addition polymerization, ring-opening polymerization, polyaddition, addition condensation or condensation polymerization); the thus-prepared resin is dissolved in a solvent to prepare a resin solution; an appropriate emulsifier is dissolved in the thus-prepared resin solution; and water is added to the resultant solution for phase inversion emulsification.

### —Anionic Surfactant—

Examples of anionic surfactants include alkylbenzene sulfonic acid salts, α-olefin sulfonic acid salts, phosphates, and anionic surfactants having a fluoroalkyl group. Of these, the anionic surfactants having a fluoroalkyl group are preferable. Examples of the anionic surfactants having a fluoroalkyl group include fluoroalkyl carboxylic acids having 2 to 10 carbon atoms or metal salts thereof, disodium perfluorooctanesulfonylglutamate, sodium-3-[ω-fluoroalkyl (C6 to C11)oxy]-1-alkyl (C3 to C4) sulfonate, sodium-3-[ω-fluoroalkanoyl (C6 to C8)-N-ethylamino]-1-propanesulfonate, fluoroalkyl (C11 to C20) carboxylic acids or metal salts thereof, perfluoroalkyl (C7 to C13) carboxylic acids or metal salts thereof, perfluoroalkyl (C4 to C12) sulfonic acid or metal salts thereof, perfluorooctanesulfonic acid diethanol amide, N-propyl-N-(2-hydroxyethyl)perfluorooctanesulfone amide, perfluoroalkyl (C6 to C10) sulfoneamidepropyltrimethylammonium salts, perfluoroalkyl (C6 to C10)-N-ethylsulfonyl glycin salts, and monoperfluoroalkyl(C6 to C16)ethylphosphate ester.

Examples of commercially available products of the fluoroalkyl group-containing anionic surfactants include, but not limited to, SURFLON S-111, S-112 and S-113 (manufactured by Asahi Glass Co., Ltd.); FLUORAD FC-93, FC-95, FC-98 and FC-129 (manufactured by Sumitomo 3M Limited); UNIDYNE DS-101 and DS-102 (manufactured by Daikin Industries, Ltd.); MEGAFACE F-110, F-120, F-113, F-191, F-812 and F-833 (manufactured by Dainippon Ink and Chemicals, Incorporated); EETOP EF-102, 103, 104, 105, 112, 123A, 123B, 306A, 501, 201 and 204 (manufactured by Tohchem Products Co., Ltd.); FTERGENT F-100 and F-150 (manufactured by NEOS COMPANY LIMITED).

Moreover, sodium dodecyldiphenyl ether sulfonate, and the like are preferable, because of its easy-availability at low cost, and no problem in safety.

### <Organic Solvent Removing Step>

The organic solvent removing step is a step of removing the organic solvent from the emulsion or dispersion liquid.

### —Removal of Organic Solvent—

The organic solvent is removed from emulsified slurry (emulsion or dispersion liquid) obtained by emulsification or dispersion. The method for removing the organic solvent is performed as follows: (1) the entire reaction system is gradually increased in temperature to completely evaporate the organic solvent contained in oil droplets; or (2) the emulsified dispersion is sprayed in a dry atmosphere to completely remove and evaporate the water insoluble organic solvent contained in oil droplets together with the aqueous dispersant, whereby fine toner particles are formed. By removing the organic solvent, toner particles are formed. The thus-formed toner particles are subjected to washing, drying, etc., and then, if necessary, to classification, etc. Classification is performed by removing very fine particles using a cyclone, a decanter, a centrifugal separator, etc. in the liquid. Alternatively, after drying, the formed powdery toner particles may be classified.

The toner particles produced through the above-described steps may be mixed with, for example, a colorant, a releasing agent and a charge controlling agent, or a mechanical impact may be applied to the resultant mixture (toner particles) for preventing particles of the releasing agent, etc. from dropping off from the surfaces of the toner particles. Examples of the method for applying a mechanical impact include a method in which an impact is applied to a mixture using a high-speed rotating blade, and a method in which impact is applied by putting mixed particles into a high-speed air flow and accelerating the air speed such that the particles collide with one another or that the particles are crashed into a proper collision plate. Examples of apparatuses used in these methods include ANGMILL (manufactured by Hosokawa Micron Corporation), an apparatus produced by modifying I-type mill (manufactured by Nippon Pneumatic Mfg. Co., Ltd.) so that the pulverizing air pressure thereof is decreased, hybridization system (manufactured by Nara Machinery Co., Ltd.), kryptron system (manufactured by Kawasaki Heavy Industries, Ltd.), and automatic mortar.

### <Other Components of Toner>

Other components of the toner are not particularly limited and may be appropriately selected depending on the intended purpose. Examples thereof include inorganic fine particles, flowability improver, cleanability improver, magnetic material, and metal soaps.

### —Inorganic Fine Particles—

The inorganic fine particles are used as an external additive for imparting, for example, fluidity, developability and charging ability to the toner particles. The inorganic fine particles are not particularly limited and may be appropriately selected depending on the intended purpose. Examples thereof include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. These inorganic fine particles may be used alone or in combination.

In addition to inorganic fine particles having a large particle diameter of 80 nm to 500 nm in terms of primary average particle diameter, inorganic fine particles having a small particle diameter can be preferably used as inorganic fine particles for assisting the fluidity, develop ability, and charging ability of the toner. In particular, hydrophobic silica and hydrophobic titanium oxide are preferably used as the inorganic fine particles having a small particle diameter. The primary average particle diameter of the inorganic fine particles is preferably 5 nm to 50 nm, more preferably 10 nm to 30 nm. The BET specific surface area of the inorganic fine particles is preferably 20 m²/g to 500 m²/g. The amount of the inorganic fine particles contained in the toner is preferably 0.01% by mass to 5% by mass, more preferably 0.01% by mass to 2.0% by mass.

### —Flowability Improver—

The flowability improver is an agent for performing surface treatment to improve hydrophobic properties, and is capable of inhibiting the degradation of flowability or charging ability under high humidity environment. Specific examples of the flowability improver include silane coupling agents, silylation agents, silane coupling agents having a fluorinated alkyl group, organotitanate coupling agents, aluminum coupling agents, silicone oils, and modified silicone oils. It is preferable that the silica and titanium oxide be subjected to surface treatment with such a flowability improver and used as hydrophobic silica and hydrophobic titanium oxide.

### —Cleanability Improver—

The cleanability improver is an agent added to the toner to remove the developer remaining on a photoconductor or a primary transfer member after transfer. Specific examples of the cleanability improver include metal salts of fatty acids such as stearic acid (e.g., zinc stearate and calcium stearate), polymer fine particles formed by soap-free emulsion polymerization, such as polymethylmethacrylate fine particles and polystyrene fine particles. The polymer fine particles preferably have a relatively narrow particle size distribution. It is preferable that the volume average particle diameter thereof be 0.01 μm to 1 μm.

### —Magnetic Material—

The magnetic material is not particularly limited and may be appropriately selected from those known in the art depending on the intended purpose. Examples thereof include iron powder, magnetite and ferrite. Of these, one having a white color is preferable in terms of color tone.

### <Preferred Embodiment of Toner>

The aqueous medium contains acrylic resin fine particles, and further contains anionic resin fine particles having an average particle diameter of 5 nm to 50 nm and an anionic surfactant.

Hereinafter, a more preferred embodiment of the case where the aqueous medium containing the anionic resin fine particles having an average particle diameter of 5 nm to 50 nm and the anionic surfactant is used will be specifically described.

The toner obtained by the aforementioned method contains resin fine particles adhere to a surface of the toner particle that is a core formed of a toner material mainly containing a colorant and a binder resin. The average particle diameter of the toner is adjusted under the emulsification or dispersion conditions of stirring the aqueous medium in the emulsification step.

The anionic resin fine particles are attached onto the surface of the toner, and fused to and integrated with the surface of the toner particle to form a relatively hard surface. Since the anionic resin fine particles have anionic properties, the anionic resin fine particles can adsorb on the liquid droplet containing the toner material to suppress coalescence between the liquid droplets. This is important for regulating the particle size distribution of the toner. Further, the anionic resin fine particles can impart negative charging ability to the toner. In order to attain these effects, the anionic resin fine particles preferably have an average particle diameter of 5 nm to 50 nm.

### <Tone Properties>

### —Glass Transition Temperature, Tg, of Toner—

The glass transition temperature, Tg, of the toner is not particularly limited and may be appropriately selected depending on the intended purpose. The glass transition temperature of the toner is preferably 20° C. to 55° C.

When the glass transition temperature, Tg, is lower than 20° C., the formed toner may have degraded heat-resistant storage stability, possibly causing toner blocking. When the glass transition temperature, Tg, is higher than 55° C., the lower limit fixing temperature of the formed toner increases, and the formed toner may have insufficient low-temperature fixing ability.

### —Particle Diameter of Toner—

The toner particle has a volume average particle diameter of 1 μm to 8 μm, more preferably 3 μm to 7 μm. When the volume average particle diameter of the toner is less than 3 μm, toner dust is likely to be generated in the primary transfer and the secondary transfer. On the other hand, when the volume average particle diameter of the toner is more than 7 μm, the dot reproducibility is unsatisfactory and the granularity of a halftone part is also deteriorated, and a high-definition image may not be obtained.

The ratio of the volume average particle diameter (Dv) to the number average particle diameter (Dn), i.e., Dv/Dn, in the toner particle produced by the production method of the present invention is not particularly limited and may be appropriately selected depending on the intended purpose. The ratio Dv/Dn is preferably 1.25 or less, more preferably 1.05 to 1.25. When the ratio Dv/Dn is less than 1.05, the following problems occur. Specifically, in the case of a two-component developer, toner fusion to a carrier surface occurs during long term stirring in a developing device, which may cause decrease in the charging ability of the carrier, and poor cleanability. In the case of a one-component developer, toner filming to a developing roller or toner fusing to members, such as a blade to form a thin toner film, may easily occurs. On the other hand, when the ratio Dv/Dn exceeds 1.25, it becomes difficult to provide a high-resolution, high-quality image, and variations in toner particle diameter may increase after toner consumption or toner supply in the developer. Also, the distribution of the charge amount of the toner is broadened, making it difficult to obtain a high-quality image. When the ratio Dv/Dn is 1.25 or lower, the distribution of the charge amount becomes uniform, which reduces fogging on the background.

When the ratio Dv/Dn is 1.05 to 1.25, the resultant toner is excellent in all of storage stability, low-temperature fixing ability, and hot offset resistance. In particular, when the toner is used in a full color copier, the gloss of images is excellent. When this ratio falls within this range in the case of the two-component developer, variations in toner particle diameter are small in the developer even after toner consumption and toner supply have been repeated for a long time, and in addition, even after a long time stirring in the developing device, excellent developing ability can be ensured. Moreover, when this requirement is met in the case of the one-component developer, variations in toner particle diameter decrease even after toner consumption or toner supply, and toner filming to a developing roller and toner fusing to members, such as a blade to form a thin toner film, are prevented, and in addition, even after long-time use of the developing device, i.e. long-time stirring of developer, excellent and stable developing ability can be ensured. Thus, a high-quality image can be obtained.

### —Volume Average Particle Diameter (Dv) and Number Average Particle Diameter (Dn) of Toner—

The volume average particle diameter (Dv) and the number average particle diameter (Dn) of the toner can be measured as follows. Specifically, using a particle size analyzer (“MULTISIZER III,” manufactured by Beckman Coulter Inc.) with the aperture diameter being set to 100 μm, and the obtained measurements are analyzed with an analysis software (Beckman Coulter MULTISIZER 3 Version 3.51). More specifically, 0.5 mL of a 10% by mass surfactant (alkylbenzene sulfonate, Neogen SC-A, manufactured by Daiichi Kogyo Seiyaku Co., Ltd.) is charged to a 100 mL-glass beaker, and 0.5 g of a toner sample is added thereto, followed by stirring with a microspatula. Subsequently, 80 mL of ion-exchanged water is added to the beaker. The obtained dispersion liquid is subjected to dispersion treatment for 10 min using an ultrasonic wave dispersing device (W-113MK-II, manufactured by Honda Electronics Co., Ltd.). The resultant dispersion liquid is measured using MULTISIZER III and ISOTON III (manufactured by Beckman Coulter Inc.) serving as a solution for measurement. The dispersion liquid containing the toner sample is dropped so that the concentration indicated by the meter falls within a range of 8%±2%. In this measuring method, it is important in terms of reproducibility of measuring the particle size that the concentration is adjusted to the range of 8%±2%. When the concentration indicated by the meter falls within the range of 8%±2%, no error is occurred in the measurement of the particle size.

### —Average Circularity of Toner—

The average circularity of the toner particles is not particularly limited and may be appropriately selected depending on the intended purpose. It is preferably 0.950 to 0.990.

When the average circularity of the toner particles is less than 0.950, the image uniformity upon development may be deteriorated, or the efficiency of transfer of the toner from the electrophotographic photoconductor to the intermediate transfer medium or from the intermediate transfer medium to the recording medium may be lowered. Consequently, uniform transfer may not be realized. The toner is produced by emulsification treatment in the aqueous medium. The toner particle is effective in reducing the particle diameter of the color toner and in realizing a toner shape having an average circularity in the above-defined range.

The average circularity of the toner is defined by the following equation.

Average circularity SR=(Circumferential length of a circle having the same area as projected particle area/Circumferential length of projected particle image)×100(%)

The average circularity of the toner is measured using a flow-type particle image analyzer (“FPIA-2100,” manufactured by SYSMEX CORPORATION), and analyzed using an analysis software (FPIA-2100 Data Processing Program for FPIA Version00-10). Specifically, into a 100 mL glass beaker, 0.1 mL to 0.5 mL of a 10% by mass surfactant (NEOGEN SC-A, an alkylbenzene sulfonate, manufactured by Dai-ichi Kogyo Seiyaku Co., Ltd.) is charged, and 0.1 g to 0.5 g of a toner is added, followed by stirring with a microspatula. Subsequently, 80 mL of ion-exchanged water is added to the beaker. The obtained dispersion liquid is subjected to dispersion treatment for 3 min using an ultrasonic wave dispersing device (manufactured by Honda Electronics Co., Ltd.). Using FPIA-2100, the shape and distribution of toner particles are measured until the dispersion liquid has a concentration of 5,000 number per μL to 15,000 number per μL. In this measuring method, it is important in terms of reproducibility in measuring the average circularity that the concentration of the dispersion liquid is adjusted to the range of 5,000 number per μL to 15,000 number per μL. To obtain the above-mentioned concentration of the dispersion liquid, it is necessary to change the conditions of the dispersion liquid, namely the amounts added of the surfactant and of the toner. The required amount of the surfactant varies depending on the hydrophobicity of the toner, similar to the measurement of the toner particle diameter. When the surfactant is added in large amounts, noise is caused by foaming. When the surfactant is added in small amounts, the toner cannot be sufficiently wetted, leading to insufficient dispersion. Also, the amount of the toner added varies depending on its particle diameter. When the toner has a small particle diameter, it needs to be added in small amounts. When the toner has a large particle diameter, it needs to be added in large amounts. In the case where the toner particle diameter is 3 μm to 7 μm, the dispersion liquid concentration can be adjusted to the range of 5,000 number per μL to 15,000 number per μL by adding 0.1 g to 0.5 g of the toner.

### —Volume Specific Resistance of Toner—

The common logarithmic value Log ρ of the volume specific resistance ρ (Ωcm) of the toner is preferably 10.9 Log Ωcm to 11.4 Log Ωcm. As a result, dispersion state of a colorant and the like in the toner is excellent, thereby obtaining excellent toner charge stability, and causing less toner scattering and fogging. When the common logarithmic value Log ρ of the volume specific resistance ρ (Ωcm) of the toner is smaller than 10.9 Log Ωcm, the conductivity becomes higher to cause charging failures. As a result, background smear, toner scattering, etc. tend to increasingly occur. Moreover, an abnormal image may be formed due to electrostatic offset, and a high quality image may not be stably formed. When it is greater than 11.4 Log Ωcm, the resistance becomes higher to increase the charge amount, possibly decreasing the image density. —BET Specific Surface Area of Toner—

The BET specific surface area of the toner is preferably 0.5 m²/g to 4.0 m²/g, more preferably 0.5 m²/g to 2.0 m²/g. When the BET specific surface area is smaller than 0.5 m²/g, the toner particles are covered densely with the resin fine particles, which impair the adhesion between recording paper and the binder resin inside the toner particles. As a result, the lower limit fixing temperature may be elevated. In addition, the resin fine particles prevent wax from oozing out, and the releasing effect of the wax cannot be obtained, causing offset. When the BET specific surface area of the toner exceeds 4.0 m²/g, organic fine particles remaining on the toner particle surface considerably project as protrusions. The resin fine particles remain as coarse multilayers and impair the adhesion between recording paper and the binder resin inside the toner particles. As a result, the lower limit fixing temperature may be elevated. In addition, the resin fine particles prevent wax from oozing out, and the releasing effect of the wax cannot be obtained, causing offset. Furthermore, the additives protrude to form irregularities on the toner surface, which easily affects the image quality.

Color of the toner is not particularly limited and may be appropriately selected depending on the intended purpose, and is at least one selected from a black toner, a cyan toner, a magenta toner and a yellow toner. The toner of each color can be obtained by appropriately selecting types of the colorants. A full-color toner is preferable.

### (Developer)

The developer of the present invention at least contains the toner of the present invention. The developer may further contain appropriately selected other components such as a carrier. Examples of the developer include a one-component developer and a two-component developer. For high-speed printers responding to the recent increase in information processing speed, the two-component developer is preferably used from the viewpoint of elongating the service life.

In the case of the one-component developer using the toner, variations in toner particle diameter decrease even after toner consumption or toner supply, and toner filming to a developing roller as a developer bearing member and toner fusing to a layer regulating member, such as a blade to form a thin toner film, are prevented, and in addition, even after long-time use of the developing device, i.e. long-time stirring of a developer, excellent and stable developing ability can be ensured. Thus, a high-quality image can be obtained. In the case of the two-component developer using the toner, variations in toner particle diameter are small in the developer even after toner consumption and toner supply have been repeated for a long time, and in addition, even after a long time stirring in the developing device, excellent and stable developing ability can be ensured.

### —Carrier—

The carrier is not particularly limited and may be appropriately selected depending on the intended purpose. The carrier preferably has a core material and a resin layer coating the core material.

The material of the core material is not particularly limited and may be appropriately selected depending on the intended purpose. For example, manganese-strontium (Mn—Sr) materials, and manganese-magnesium (Mn—Mg) materials (50 emu/g to 90 emu/g) are preferably employed. Further, high magnetization materials such as iron powder (100 emu/g or more), and magnetite (75 emu/g to 120 emu/g) are preferably employed, for the purpose of securing image density. Moreover, low magnetization materials such as copper-zinc (Cu—Zn) with 30 emu/g to 80 emu/g are preferably employed because the impact toward a latent electrostatic image bearing member, on which toner particles are held in upright positions, can be relieved and because it is advantageous for improving image quality. These may be used alone or in combination.

The material of the resin layer is not particularly limited and may be appropriately selected from known resins depending on the intended purpose. Examples thereof include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acrylic monomer, copolymers of vinylidene fluoride and vinyl fluoride, fluoroterpolymers such as terpolymers of tetrafluoroethylene, vinylidene fluoride and monomer having no fluorine-containing group, and silicone resins. These may be used alone or in combination. Of these, silicone resins are particularly preferable.

The silicone resins are not particularly limited and may be appropriately selected from known silicone resins depending on the intended purpose. Examples thereof include straight silicone resins composed only of organosiloxane bond; and silicone resins that have been modified with an alkyd resin, a polyester resin, an epoxy resin, an acrylic resin, or a urethane resin.

As the silicone resins, commercially available products may be used. Examples of the straight silicone resins include KR271, KR255 and KR152 manufactured by Shin-Etsu Chemical Co., Ltd.; and SR2400, SR2406, and SR2410 manufactured by DOW CORNING TORAY SILICONE CO., LTD.

As the modified silicone resins, commercially available products may be used. Examples of the modified silicone resins include KR206 (alkyd-modified), KR5208 (acryl-modified), ES1001N (epoxy-modified), and KR305 (urethane-modified) manufactured by Shin-Etsu Chemical Co., Ltd.; and SR2115 (epoxy-modified) and SR2110 (alkyd-modified) manufactured by DOW CORNING TORAY SILICONE CO., LTD.

Each of these silicone resins may be used alone, and components capable of crosslinking reaction, charge amount controlling components and the like may be used in combination therewith.

In the resin layer conductive powder may be contained, if necessary. The conductive powder is not particularly limited and may be appropriately selected depending on the intended purpose. Examples thereof include metal powder, carbon black, titanium oxide, tin oxide, and zinc oxide. The average particle diameter of the conductive powder is not particularly limited and may be appropriately selected depending on the intended purpose. It is preferably 1 μm or less. When the average particle diameter is greater than 1 μm, it may be difficult to control the electrical resistance.

The resin layer may be formed by uniformly coating a surface of the core material with a coating solution obtained by dissolving the silicone resin or the like in a solvent, by a known coating method, followed by drying and baking. The coating method is not particularly limited and may be appropriately selected depending on the intended purpose. Examples thereof include dipping, spraying, and brushing.

The solvent is not particularly limited and may be appropriately selected depending on the intended purpose. Examples thereof include toluene, xylene, methyl ethyl ketone, methyl isobutyl ketone, cellosolve, and butyl acetate.

The baking method is not particularly limited and may be appropriately selected depending on the intended purpose. It may be external heating or internal heating. Examples of the baking method include methods using fixed electric furnace, fluid electric furnace, rotary electric furnace, or burner furnace, and methods using microwaves.

The amount of the resin layer in the carrier is not particularly limited and may be appropriately selected depending on the intended purpose. It is preferably 0.01% by mass to 5.0% by mass. When the amount is less than 0.01% by mass, the resin layer may not be uniformly formed over the surface of the core material. When the amount is more than 5.0% by mass, the resin layer becomes so thick that fusing of carrier particles occurs and thus equally-sized carrier particles may not be obtained.

The amount of the carrier contained in the two-component developer is not particularly limited and may be appropriately selected depending on the intended purpose. The amount of the carrier is preferably 90% by mass to 98% by mass, more preferably 93% by mass to 97% by mass.

In the case of the two-component developer, the mixing ratio of the toner to the carrier is preferably 1 part by mass to 10.0 parts by mass of the toner relative to 100 parts by mass of the carrier.

The weight average particle diameter of the carrier Dw is not particularly limited but is preferably 15 μm to 40 μm. When the weight average particle diameter is smaller than 15 μm, carrier adhesion, which is a phenomenon that the carrier is also disadvantageously transferred in the transfer step, is likely to occur. When the weight average particle diameter is larger than 40 μm, the carrier adhesion is less likely to occur. In this case, however, when the toner density is increased to provide a high image density, there is a possibility that background smear is likely to occur. Further, when the dot diameter of a latent image is small, variation in dot reproducibility is so large that the granularity in highlight parts may be degraded.

The weight average particle diameter (Dw) of the carrier is calculated on the basis of the particle size distribution of the particles measured on a number basis; i.e., the relation between the number based frequency and the particle diameter. In this case, the weight average particle diameter (Dw) is expressed by Equation (1);

Dw={1/Σ(nD³)}×{Σ(nD⁴)} Equation (1)

in Equation (1) D represents a typical particle diameter (μm) of particles present in each channel, and “n” represents the total number of particles present in each channel. It should be noted that each channel is a length for equally dividing the range of particle diameters in the particle size distribution chart, and 2 μm is employed for each channel in the present invention. For the typical particle diameter of particles present in each channel, the minimum particle diameter of the particles present in each channel is employed.

In addition, the number average particle diameter (Dp) of the carrier or the core material particles are calculated on the basis of the particle diameter distribution measured on a number basis. The number average particle diameter (Dp) is expressed by Equation (2):

Dp=(1/ΣN)×(ΣnD) Equation (2)

in Equation (2) N represents the total number of particles measured, “n” represents the total number of particles present in each channel and D represents the minimum particle diameter of the particles present in each channel (2 μm).

For a particle size analyzer used for measuring the particle size distribution, a micro track particle size analyzer (Model HRA9320-X100, manufactured by Honewell Co.) may be used. The evaluation conditions are as follows.

(1) Range of particle diameters: 8 μm to 100 μm

(2) Channel length (width): 2 μm

(3) Number of channels: 46

(4) Refraction index: 2.42

### (Image Forming Method and Image Forming Apparatus)

An image forming method of the present invention includes a charging step, an exposing step, a developing step, a transfer step, a fixing step, and a cleaning step, and if necessary further includes other steps.

The transfer step may transfer a visible image directly onto a recording medium, or may transfer a visible image via an intermediate transfer medium onto a recording medium. In the case of transferring the visible image via the intermediate transfer medium onto the recording medium, the transfer step preferably includes a primary transfer step of primarily transferring the visible image onto the intermediate transfer medium and a secondary transfer step of secondarily transferring the transferred visible image from the intermediate transfer medium onto the recording medium.

An image forming apparatus of the present invention includes an electrophotographic photoconductor (also referred to as photoconductor, or latent electrostatic image bearing member), a charging unit, an exposing unit, a developing unit, a transfer unit, a fixing unit, and a cleaning unit, and if necessary further includes other units.

The transfer unit preferably includes a primary transfer unit, and a secondary transfer unit. The charging step, the developing step, the primary transfer step, the secondary transfer step, the fixing step, the cleaning step are suitably performed respectively by the charging unit, the developing unit, the primary transfer unit, the secondary transfer unit, the fixing unit, and the cleaning unit.

In the image forming method, the linear velocity of transferring a visible image (toner image) onto a recording medium is 300 mm/sec to 1,000 mm/sec in the secondary transfer step, and the transfer time at a nip portion in the secondary transfer unit is preferably 0.5 msec to 20 msec.

Further, the full-color image forming apparatus of the present invention is preferably of a tandem type including a plurality of sets of an electrophotographic photoconductor, a charging unit, an exposing unit, a developing unit, a transfer unit, and a cleaning unit. In the so-called tandem type in which a plurality of electrophotographic photoconductors are provided, and development is carried out one color by one color upon each rotation, a latent electrostatic image formation step and a development and transfer step are carried out for each color to form each color toner image. Accordingly, the difference in speed between single color image formation and full color image formation is so small that the tandem type can advantageously apply to high-speed printing. In this case, the color toner images are formed on respective separate electrophotographic photoconductors, and the color toner layers are stacked (color superimposition) to form a full color image. Accordingly, when a variation in properties, for example, a difference in charging ability between color toner particles exists, a difference in amount of the developing toner occurs between the individual color toner particles. As a result, a change in hue of secondary color by color superimposition is increased, and the color reproducibility is lowered.

It is necessary for the toner used in the tandem image forming method to satisfy the requirements that the amount of the developing toner for regulating the balance of the colors is stabilized (no variation in developing toner amount between respective color toner particles), and the adherence to an electrophotographic photoconductor and to a recording medium is uniform between the respective color toner particles. With respect to these points, the toner of the present invention is preferable.

### <Electrophotographic Photoconductor>

The electrophotographic photoconductor is not particularly limited as to the material, shape, structure, size and the like, and may be appropriately selected depending on the intended purpose. For the shape, drum-shape, sheet-shape, and endless belt-shape are exemplified. The structure of the electrophotographic photoconductor may be a single-layer structure or a laminate structure. The size of the electrophotographic photoconductor may be appropriately selected in accordance with the size and specification of the image forming apparatus employed. Examples of the material of the electrophotographic photoconductor include inorganic photoconductors such as amorphous silicon, selenium, CdS, and ZnO; and organic photoconductors (OPC) such as polysilane, and phthalopolymethine.

The amorphous silicon photoconductor is provided with a photosensitive layer composed of a-Si, on a substrate which is heated at 50° C. to 400° C., by a layer forming method such as vacuum evaporation method, sputtering method, ion-plating method, heat CVD method, optical CVD method, and plasma CVD method. Of these layer forming methods, plasma CVD method is particularly preferable. Specifically, a method is preferable in which a raw material gas is decomposed by means of a high frequency wave or microwave glow discharge, and a photosensitive layer composed of a-Si is formed on a substrate with the use of the decomposed gas.

The organic photoconductors (OPC) are widely used for the following reasons: (1) optical properties such as its width of optical absorption wavelength range, and its largeness of optical absorption amount; (2) electric properties such as high-sensitivity, and stable charge property; (3) wide selection of materials; (4) ease of production; (5) low-cost; and (6) non-toxicity. Layer structures of such organic photoconductors are broadly classified into single-structure and laminate structure.

A single-layer photoconductor is provided with a substrate, and a single photosensitive layer on the substrate, and if necessary, further provided with a protective layer, an intermediate layer and other layers.

The photoconductor of the laminate structure is provided with a substrate and a laminated photosensitive layer, which has at least a charge generating layer, and a charge transporting layer in this order, on the substrate, and if necessary, further provided with a protective layer, an intermediate layer, and other layers.

### <Charging Step and Charging Unit>

The charging step is a step of charging a surface of a latent electrostatic image bearing member, and is carried out by means of the charging unit.

The charging unit is not particularly limited and may be appropriately selected depending on the intended purpose, as long as it is capable of applying a voltage to the surface of the latent electrostatic image bearing member to uniformly charge the surface. The charging units are broadly classified into the following two types: (1) contact charging units each configured to charge a surface of a latent electrostatic image bearing member in a contact manner; and (2) non-contact charging units each configured to charge a surface of a latent electrostatic image bearing member in a non-contact manner.

The charging unit preferably applies at least an alternating voltage superimposed on direct voltage. The application of the alternating voltage superimposed on direct voltage can stabilize the surface voltage of the electrophotographic photoconductor to a desired value as compared with the application of only a direct current voltage. Accordingly, further uniform charging can be realized. The charging unit preferably performs charging by bringing a charging member into contact with the electrophotographic photoconductor and applying the voltage to the charging member. When charging is carried out by bringing the charging member into contact with the electrophotographic photoconductor and applying the voltage to the charging member, the effect of uniform charging ability attained by applying the alternating voltage superimposed on direct voltage can be further improved.

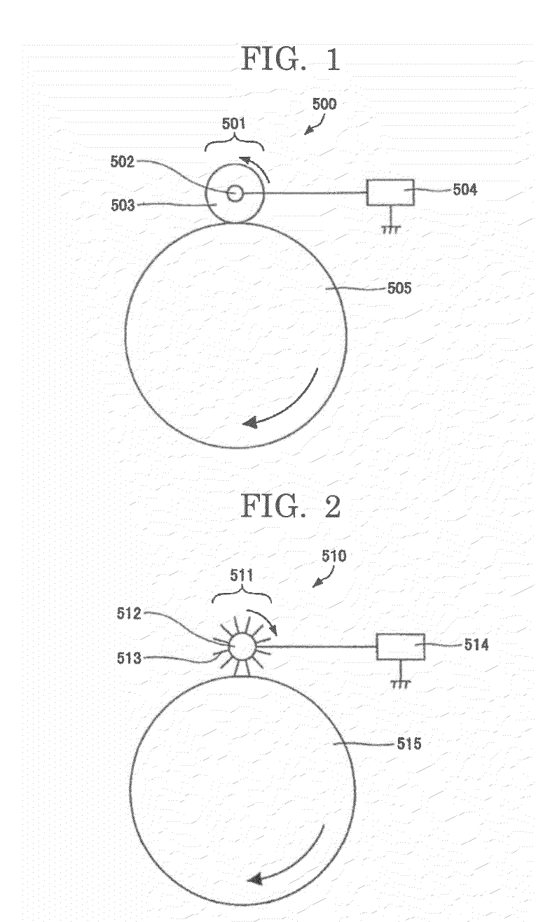

The charging unit used in the image forming method of the present invention may be a contact charging device shown in FIGS. 1 and 2.

### —Roller Charging Device—

FIG. 1 is a schematic configuration of an example of a roller charging device 500 which is one type of the contact charging devices. A photoconductor (electrophotographic photoconductor) 505 to be charged as an image bearing member is rotated at a predetermined speed (process speed) in the direction indicated by the arrow. A charging roller 501 serving as a charging member, which is brought into contact with the photoconductor 505, contains a metal core 502 and a conductive rubber layer 503 formed on the outer surface of the metal core 502 in a shape of a concentric circle, as a basic structure. The both terminals of the metal core 502 are supported with bearings (not shown) so that the charging roller enables to rotate, and the charging roller is pressed against the photoconductor drum at a predetermined pressure by a pressurizing unit (not shown). The charging roller 501 in FIG. 1 therefore rotates along with the rotation of the photoconductor 505. The charging roller 501 is generally formed with a diameter of 16 mm in which a metal core 502 having a diameter of 9 mm is coated with a conductive rubber layer 503 having a moderate resistance of approximately 100,000 Ω·cm. The power supply 504 shown in the figure is electrically connected to the metal core 502 of the charging roller 501, and a predetermined bias is applied to the charging roller 501 by the power supply 504. Thus, the surface of the photoconductor 505 is uniformly charged at a predetermined polarity and potential.

In addition to the roller charging device, the charging device used in the present invention may be any form, such as a magnetic brush charging device, a fur brush charging device, or the like. It may be appropriately selected according to a specification or configuration of an electrophotographic image forming apparatus. When the magnetic brush charging device is used as the charging device, the magnetic brush includes a charging member formed of various ferrite particles such as Zn—Cu ferrite, etc., a non-magnetic conductive sleeve to support the ferrite particles, and a magnetic roller included in the non-magnetic conductive sleeve. Moreover, in the case of using the fur brush charging device, a material of the fur brush is, for example, a fur treated to be conductive with, for example, carbon, copper sulfide, a metal or a metal oxide, and the fur is coiled or mounted to a metal or another metal core which is treated to be conductive, thereby obtaining the charging device.

### —Fur Brush Charging Device—

FIG. 2 is a schematic configuration of one example of a contact fur brush charging device 510. A photoconductor (electrophotographic photoconductor) 515 to be charged as an image bearing member is rotatably driven at a predetermined speed (process speed) in the direction indicated by the arrow. The fur brush roller 511 having a fur brush is brought into contact with the photoconductor 515, with a predetermined nip width and a predetermined pressure with respect to elasticity of a brush part 513.

The fur brush roller 511 as the contact charging device has an outer diameter of 14 mm and a longitudinal length of 250 mm. In this fur brush, a tape formed of a pile of conductive rayon fiber REC-B (manufactured by Unitika Ltd.), as a brush part 513, is spirally coiled around a metal core 512 having a diameter of 6 mm, which serves also as an electrode. A brush of the brush part 513 is of 300 denier/50 filament, and a density of 155 fibers per 1 square millimeter. This role brush is once inserted into a pipe having an internal diameter of 12 mm with rotating in a certain direction, and is set so as to be a concentric circle relative to the pipe. Thereafter, the role brush in the pipe is left in an atmosphere of high humidity and high temperature so as to twist the fibers of the fur.

The resistance of the fur brush roller 511 is 1×10⁵Ω at an applied voltage of 100 V. This resistance is calculated from the current obtained when the fur brush roller is contacted with a metal drum having a diameter of 30 mm with a nip width of 3 mm, and a voltage of 100 V is applied thereon. The resistance of the brush charging device 510 should be 10⁴Ω or more in order to prevent image defect caused by an insufficient charge at the charging nip part when the photoconductor 515 to be charged happens to have defects caused by low pressure resistance, such as pin holes thereon and an excessive leak current therefore runs into the defects. Moreover, the resistance needs to be 10⁷Ω or less in order to sufficiently charge the surface of the photoconductor 515.

The material of the fur brush is not particularly limited, and may be appropriately selected depending on the intended purpose. Examples of the material of the fur brush include, in addition to REC-B, REC-C, REC-M1, REC-M10 (manufactured by Unitika Ltd.), SA-7 (manufactured by Toray Industries, Inc.), THUNDERON (manufactured by Nihon Sanmo Dyeing Co., Ltd.), BELTRON (manufactured by Kanebo Gohsen, Ltd.), KURACARBO in which carbon is dispersed in rayon (manufactured by Kuraray Co., Ltd.), and ROVAL (manufactured by Mitsubishi Rayon Co., Ltd.). The brush is of preferably 3 denier to 10 denier per fiber, 10 filaments per bundle to 100 filaments per bundle, and 80 fibers/mm² to 600 fibers/mm². The length of the fur is preferably 1 mm to 10 mm.

The fur brush roller 511 is rotatably driven in the opposite (counter) direction to the rotation direction of the photoconductor 515 at a predetermined peripheral velocity (surface velocity), and comes into contact with a surface of the photoconductor with a velocity difference. The power supply 514 applies a predetermined charging voltage to the fur brush roller 511 so that the surface of the photoconductor is uniformly charged at a predetermined polarity and potential.

The contact charge of the photoconductor 515 with the fur brush roller 511 is performed in the following manner: charges are mainly directly injected and the surface of the photoconductor is charged at the substantially equal voltage to the applying charging voltage to the fur brush roller 511.

The charging member is not limited in its shape and may be in any shape such as a charging roller or a fur blush, as well as the fur blush roller 511. The shape can be selected according to the specification and configuration of the image forming apparatus. When a charging roller is used, it generally includes a metal core and a rubber layer having a moderate resistance of about 100,000 Ω·cm coated on the metal core. When a magnetic fur blush is used, it generally includes a charging member formed of various ferrite particles such as Zn—Cu ferrite, a non-magnetic conductive sleeve to support the ferrite particles, and a magnet roll included in the non-magnetic conductive sleeve.

### —Magnetic Brush Charging Device—

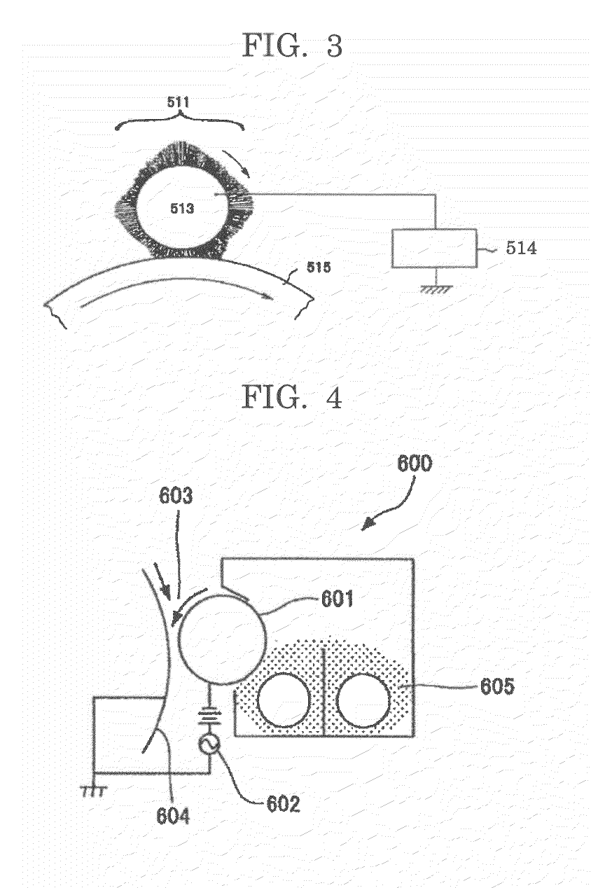

FIG. 3 is a schematic configuration of one example of a magnetic brush charging device. A photoconductor (electrophotographic photoconductor) 515 to be charged as an image bearing member is rotatably driven at a predetermined speed (process speed) in the direction indicated by the arrow. The fur brush roller 511 having a magnetic brush is brought into contact with the photoconductor 515, with a predetermined nip width and a predetermined pressure with respect to elasticity of a brush part 513.

The magnetic brush as the contact charging member is formed of magnetic particles. For the magnetic particles, Zn—Cu ferrite particles having an average particle diameter of 25 μm and Zn—Cu ferrite particles having an average particle diameter of 10 μm are mixed together in a ratio by mass of 1/0.05, so as to obtain ferrite particles having an average particle diameter of 25 μm, which have peaks at each average particle diameter, and then the ferrite particles are coated with a resin layer having a moderate resistance, to thereby form magnetic particles. The contact charging member is formed of the aforementioned coated magnetic particles, a non-magnetic conductive sleeve which supports the coated magnetic particles, and a magnet roller which is included in the non-magnetic conductive sleeve. The coated magnetic particles are disposed on the sleeve with a thickness of 1 mm so as to form a charging nip of about 5 mm-wide with the photoconductor. The width between the magnetic particle-bearing sleeve and the photoconductor is adjusted to approximately 500 μm. The magnetic roller is rotated so that the sleeve is rotated at twice in speed relative to the peripheral speed of the surface of the photoconductor in the opposite direction of the rotation of the photoconductor, to thereby slidingly rub the photoconductor. Therefore, the magnetic brush is uniformly brought into contact with the photoconductor.

### <Exposing Step and Exposing Unit>

The exposing step is a step of exposing the charged surface of the electrophotographic photoconductor to light using the exposing unit so as to form and a latent electrostatic image.

The exposure may be carried out by exposing the surface of the electrophotographic photoconductor imagewise using of the exposing unit.

The optical systems used for the exposure may be broadly classified into analogue optical systems and digital optical systems. The analogue optical systems are those projecting directly an original image onto the surface of a photoconductor, and the digital optical systems are those where image information is input as electric signals, the electric signals are then converted into optical signals and the photoconductor is exposed to form an image.

The exposing unit is not particularly limited and may be appropriately selected depending on the intended purpose, as long as it is capable of exposing imagewise on the surface of the electrophotographic photoconductor which has been charged by the charging unit. Examples thereof include various exposing devices such as a copying optical system, a rod lens array system, a laser optical system, and a liquid crystal shutter optical system, and a LED optical system.

Here, in the present invention, a backlight system for exposing the electrophotographic photoconductor imagewise from the rear surface side may be employed.

### <Developing Step and Developing Unit>

The developing step is a step of developing the latent electrostatic image using the toner and/or developer of the present invention so as to form a visible image.

The visible image may be formed by developing the latent electrostatic image using the toner and/or developer by the developing unit.

The developing unit is not particularly limited and may be appropriately selected from those known in the art as long as it is capable of developing using the toner and/or developer. For example, one that includes at least a developing unit that contains the toner and/or developer and is capable of supplying the toner and/or developer to the latent electrostatic image in a contact or noncontact manner is preferable.

The developing unit may employ either a dry developing system or a wet developing system, and may be either a single-color developing unit or a multi-color developing unit. Examples thereof include one including a stirrer that frictionally stirs the toner and/or developer so as to be charged and a rotatable magnet roller.

In the developing device, for example, the toner and the carrier are mixed and stirred, the toner is charged by friction upon stirring and is held in an upright position on the surface of the rotating magnet roller to form a magnetic brush. Since the magnet roller is arranged in the vicinity of the electrophotographic photoconductor, a part of the toner constituting the magnetic brush formed on the surface of the magnet roller is moved to the surface of the electrophotographic photoconductor by an electrical suction force. As a result, the latent electrostatic image is developed with the toner to form a visible image on the surface of the electrophotographic photoconductor.

In the present invention, when a latent electrostatic image on the photoconductor is developed, an alternating electrical field is preferably applied. In a developing device 600 shown in FIG. 4, a power supply 602 applies a vibration bias voltage as developing bias, in which a direct-current voltage and an alternating voltage are superimposed, to a developing sleeve 601 during development. The potential of background part and the potential of image part are positioned between the maximum and the minimum of the vibration bias potential. This forms an alternating electrical field, whose direction alternately changes, at a developing section 603. A toner and a carrier in the developer are intensively vibrated in this alternating electrical field, so that the toner 605 overshoots the electrostatic force of constraint from the developing sleeve 601 and the carrier, and is attached to a latent image on the photoconductor 604. The toner 605 is a toner produced by the above-described method for producing a toner of the present invention.

The difference between the maximum and the minimum of the vibration bias voltage (peak-to-peak voltage) is preferably from 0.5 kV to 5 kV, and the frequency is preferably from 1 kHz to 10 kHz. The waveform of the vibration bias voltage may be a rectangular wave, a sine wave or a triangular wave. The direct-current voltage of the vibration bias voltage is in a range between the potential at the background and the potential at the image as mentioned above, and is preferably set closer to the potential at the background from the viewpoint of inhibiting a toner deposition (fogging) on the background.

When the vibration bias voltage is a rectangular wave, it is preferred that a duty ratio be 50% or less. The duty ratio is a ratio of time when the toner leaps to the photoconductor during a cycle of the vibration bias. In this way, the difference between the peak time value when the toner leaps to the photoconductor and the time average value of bias can become very large. Consequently, the movement of the toner becomes further activated hence the toner is accurately attached to the potential distribution of the latent electrostatic image and rough deposits and an image resolution can be improved. Moreover, the difference between the time peak value when the carrier having an opposite polarity of current to the toner leaps to the photoconductor and the time average value of bias can be decreased. Consequently the movement of the carrier can be restrained and the possibility of the carrier deposition on the background can be largely reduced.

### <Transfer Step and Transfer Unit>

The transfer step is a step of transferring the visible image onto a recording medium, and can be performed by charging the latent electrostatic image bearing member, on which the visible image is formed, using the transfer charging device, more suitably performed using the transfer unit. The transfer step may be a step of directly transferring a visible image formed on a latent electrostatic image bearing member onto a recording medium, and may be a step including a primary transfer step of primarily transferring a visible image onto an intermediate transfer medium and a secondary transfer step of secondarily transferring the visible image from the intermediate transfer medium onto the recording medium. The primary transfer step and the secondary transfer step are suitably performed respectively by the primary transfer unit that transfers the visible image to the intermediate transfer medium to form a composite transfer image, and the secondary transfer unit that transfers the composite transfer image onto the recording medium.

### —Intermediate Transfer Medium—

The intermediate transfer medium is not particularly limited and may be appropriately selected from known transfer media depending on the intended purpose, and examples thereof include a transfer belt, and a transfer roller.

The stationary friction coefficient of the intermediate transfer medium is preferably 0.1 to 0.6, and more preferably 0.3 to 0.5. The volume resistance of intermediate transfer medium is preferably several Ω·cm to 10³Ω·cm. The volume resistance within the range of several Ω·cm to 10³ Ω·cm may prevent charging of the intermediate transfer medium itself, and the charge applied by a charge application unit is unlikely to remain on the intermediate transfer medium, therefore, transfer nonuniformity at the secondary transferring may be prevented and the application of transfer bias at the secondary transferring is easily performed.

Materials used for the intermediate transfer medium are not particularly limited and may be appropriately selected from those known in the art depending on the intended purpose. Examples of the materials include the followings: (1) materials with high Young's modulus (tension elasticity) used as a single layer belt such as polycarbonates (PC), polyvinylidene fluoride (PVDF), polyalkylene terephthalate (PAT), blend materials of PC/PAT, blend materials of ethylene tetrafluoroethylene copolymer (ETFE) and PC, blend materials of ETFE and PAT, blend materials of PC and PAT, and thermosetting polyimides of carbon black dispersion. These single layer belts having high Young's modulus are small in their deformation against stress during image formation and are particularly advantageous in that registration error is less likely to occur during color image formation; (2) a double or triple layer belt using the belt having high Young's modulus as described in (1) as a base layer, on which outer periphery a surface layer and an optional intermediate layer are formed. The double or triple layer belt has a capability of preventing print defect of unclear center portion in a line image that is caused by hardness of the single layer belt; and (3) an elastic belt incorporating a resin, a rubber or an elastomer with relatively low Young's modulus. This belt is advantageous in that there is almost no print defect of unclear center portion in a line image owing to its softness. Additionally, by making width of the belt wider than drive roller or tension roller and thereby using the elasticity of edge portions that extend over the rollers, it can prevent meandering of the belt. It is also cost effective for requiring neither ribs nor units for prevention of meandering.

Of these, the elastic belt (3) is preferable in particular.

The elastic belt deforms corresponding to the surface roughness of a toner layer and the recording medium having poor smoothness in the transfer section. In other words, since elastic belts deform complying with local roughness and an appropriate adhesiveness can be obtained without excessively increasing the transfer pressure against the toner layer, it is possible to obtain transfer images having excellent uniformity with no void in characters even on a recording medium having poor smoothness.

The resins used for the elastic belt are not particularly limited and may be appropriately selected depending on the intended purpose. Examples thereof include polycarbonate resins, fluorine resins (such as ETFE and PVDF); polystyrenes, chloropolystyrenes, poly-α-methylstyrenes; styrene resins (homopolymers or copolymers containing styrene or styrene substituents) such as styrene-butadiene copolymers, styrene-vinyl chloride copolymers, styrene-vinyl acetate copolymers, styrene-maleic acid copolymers, styrene-acrylate copolymers (such as styrene-methyl acrylate copolymers, styrene-ethyl acrylate copolymers, styrene-butyl acrylate copolymers, styrene-octyl acrylate copolymers, and styrene-phenyl acrylate copolymers), styrene-methacrylate copolymers (such as styrene-methyl methacrylate copolymers, styrene-ethyl methacrylate copolymers and styrene-phenyl methacrylate copolymers); styrene-α-chloromethyl acrylate copolymers, styrene-acrylonitrile acrylate copolymers, methyl methacrylate resins, and butyl methacrylate resins; ethyl acrylate resins, butyl acrylate resins, modified acrylic resins (such as silicone-modified acrylic resins, vinyl chloride resin-modified acrylic resins and acrylic urethane resins); vinyl chloride resins, styrene-vinyl acetate copolymers, vinyl chloride-vinyl acetate copolymers, rosin-modified maleic acid resins, phenol resins, epoxy resins, polyester resins, polyethylene resins, polypropylene resins, polybutadiene resins, polyvinylidene chloride resins, ionomer resins, polyurethane resins, silicone resins, ketone resins, ethylene-ethylacrylate copolymers, xylene resins, polyvinylbutylal resins, polyamide resins and modified polyphenylene oxide resins. These resins may be used alone or in combination.

The rubbers used for the elastic belt are not particularly limited and may be appropriately selected depending on the intended purpose. Examples thereof include natural rubber, butyl rubber, fluorine-based rubber, acryl rubber, EPDM rubber, NBR rubber, acrylonitrile-butadiene-styrene rubber, isoprene rubber, styrene-butadiene rubber, butadiene rubber, ethylene-propylene rubber, ethylene-propylene terpolymers, chloroprene rubber, chlorosulfonated polyethylene, chlorinated polyethylene, urethane rubber, syndiotactic 1,2-polybutadiene, epichlorohydrin-based rubber, silicone rubber, fluorine rubber, polysulfide rubber, polynorbornene rubber, hydrogenated nitrile rubber. These may be used alone or in combination.

The elastomers used for the elastic belt are not particularly limited and may be appropriately selected depending on the intended purpose. Examples thereof include thermoplastic elastomers, of polystyrene, polyolefin, polyvinyl chloride, polyurethane, polyamide, polyurea, polyester and fluorine resins. These may be used alone or in combination.

The conductive agent used for the elastic belt for adjusting resistance is not particularly limited and may be appropriately selected depending on the intended purpose. Examples thereof include carbon black, graphite, metal powders such as aluminum and nickel; conductive metal oxides such as tin oxide, titanium oxide, antimony oxide, indium oxide, potassium titanate, antimony tin oxide (ATO), and indium tin oxide (ITO). The conductive metal oxides may be coated with insulating fine particles such as barium sulfate, magnesium silicate, and calcium carbonate.

The material used for the surface layer of the elastic belt is required to prevent contamination of the photoconductor due to elastic material as well as to reduce the surface frictional resistance of the elastic belt so that toner adhesion force is decreased while improving the cleaning ability and the secondary transfer property. The surface layer preferably contains a binder resin such as polyurethane resins, polyester resins, and epoxy resins and materials that reduce surface energy and enhance lubrication, for example, powders or particles such as fluorine resins, fluorine compounds, carbon fluoride, titanium dioxide, and silicon carbide. In addition, it is possible to use materials such as fluorine rubbers that are treated with heat so that a fluorine-rich layer is formed on the surface of the belt and the surface energy is reduced.

A method for producing the elastic belt is not particularly limited and may be appropriately selected depending on the intended purpose. Examples thereof include (1) centrifugal forming in which material is poured into a rotating cylindrical mold to form a belt, (2) spray coating method in which a liquid coating solution is sprayed to form a film, (3) dipping method in which a cylindrical mold is dipped into a solution of material and then pulled out, (4) injection mold method in which material is injected into inner and outer molds, (5) a method in which a compound is applied onto a cylindrical mold and the compound is vulcanized and ground.

A method for preventing the elastic belt from elongating is not particularly limited and may be appropriately selected depending on the intended purpose. Examples thereof include (1) a method in which materials that prevent elongation are added to a core layer and (2) a method in which a rubber layer is formed on a core layer which is less stretchable.

The material that prevents elongation is not particularly limited and may be appropriately selected depending on the intended purpose. For example, natural fibers such as cotton, and silk; synthetic fibers such as polyester fibers, nylon fibers, acrylic fibers, polyolefin fibers, polyvinyl alcohol fibers, polyvinyl chloride fibers, polyvinylidene chloride fibers, polyurethane fibers, polyacetal fibers, polyfluoroethylene fibers, and phenol fibers; inorganic fibers such as carbon fibers, glass fibers, and boron fibers; metal fibers such as iron fibers, and copper fibers; and materials that are in the form of a weave or thread may be preferably used.

The method for forming the core layer is not particularly limited and may be appropriately selected depending on the intended purpose. Examples thereof include (1) a method in which a weave that is woven in a cylindrical shape is placed on a mold or the like and a coating layer is formed on top of it, (2) a method in which a weave that is woven in a cylindrical shape is dipped in a liquid rubber or the like so that coating layer(s) are formed on one side or on both sides of the core layer and (3) a method in which a thread is twisted helically around a mold or the like with an arbitrary pitch, and then a coating layer is formed thereon.

The thickness of the coated layer depends on the hardness of the coated layer. As the coated layer comes to thicker, elongation and contraction of the surface comes to more significant and the surface layer is susceptible to cracks, causing significant elongation and contraction of images, therefore, excessive thickness such as about 1 mm or more is undesirable.

The transfer unit, i.e. the primary transfer unit and the secondary transfer unit, preferably has at least a transferer that is configured to charge so as to separate the visible image formed on the latent electrostatic image bearing member and transfer the visible image onto the recording medium. One transferer or two transferers may be used. Examples of the transferer include corona transferers utilizing corona discharge, transfer belts, transfer rollers, pressure-transfer rollers, and adhesion-transferers.

A typical recording medium is plain paper, and it is not particularly limited and may be appropriately selected depending on the intended purpose, as long as it is capable of receiving transferred, unfixed image after developed; and PET bases for OHP may also be used.

### <Fixing Step and Fixing Unit>

The fixing step is a step of fixing the transferred visible image on a recording medium, suitably performed using the fixing unit.

The fixing unit is not particularly limited and may be appropriately selected depending on the intended purpose, however, a fixing device having a fixing member and a heat source for heating the fixing member is preferably used.

The fixing member is not particularly limited and may be appropriately selected depending on the intended purpose, as long as they can be in contact with each other to form a nip. Examples of the fixing member include a combination of an endless belt and a roller, and a combination of a roller and a roller. In view of shorter warm-up period and energy saving, a combination of an endless belt and a roller or induction heating where the transferred image is heated from the surfaces of the fixing member, is preferably employed.

The fixing member is exemplified by conventional heating and pressurizing units, i.e. a combination of a heating unit and a pressurizing unit. For the heating and pressurizing units, in the case of the combination of an endless belt and a roller, it is exemplified by a combination of a heating roller, a pressurizing roller, and an endless belt, and in the case of the combination of a roller and a roller, it is exemplified by a combination of a heating roller and a pressurizing roller.

The fixing unit including a heating roller that is formed of a magnetic metal and is heated by electromagnetic induction; a fixation roller disposed parallel to the heating roller; an endless belt-type toner heating medium (a heating belt) that is stretched around the heating roller and the fixation roller and rotated by these rollers, while being heated by the heating roller; and a pressure roller that is brought into pressure contact with the fixation roller through the heating belt and is rotated in a forward direction relative to the heating belt to form a fixation nip part. The fixing step can realize a temperature rise in the fixation belt in a short time and can realize stable temperature control. Further, even when a recording medium having a rough surface is used, during the fixation, the fixation belt acts in conformity to the surface of the transfer paper to some extent and, consequently, satisfactory fixing ability can be realized.

The fixing unit is preferably of an oil-less type or a minimal oil-coated fixing type. To this end, preferably, the toner particles to be fixed contain a releasing agent (wax) in a finely dispersed state in the toner particles. In the toner in which the releasing agent is finely dispersed in the toner particle, the releasing agent is likely to ooze out during fixation. Accordingly, in the oil-less fixing device or even when an oil coating effect becomes unsatisfactory in the minimal oil-coated fixing device, the transfer of the toner to the belt can be suppressed. In order that the releasing agent is present in a dispersed state in the toner particle, preferably, the releasing agent and the binder resin are not compatible with each other. The releasing agent can be finely dispersed in the toner particle, for example, by taking advantage of the shear force of kneading during the toner production. The dispersion state of the releasing agent can be determined by observing a thin film section of the toner particle under a TEM. The dispersion diameter of the releasing agent is not particularly limited but is preferably small. However, when the dispersion diameter is excessively small, the releasing agent may not be sufficiently oozed out during the fixation. Accordingly, when the releasing agent can be observed at a magnification of 10,000 times, it can be determined that the releasing agent is present in a dispersed state. When the releasing agent is so small that the releasing agent cannot be observed at a magnification of 10,000 times, the releasing agent may not be sufficiently oozed out during the fixation even when the releasing agent is finely dispersed in the toner particle.

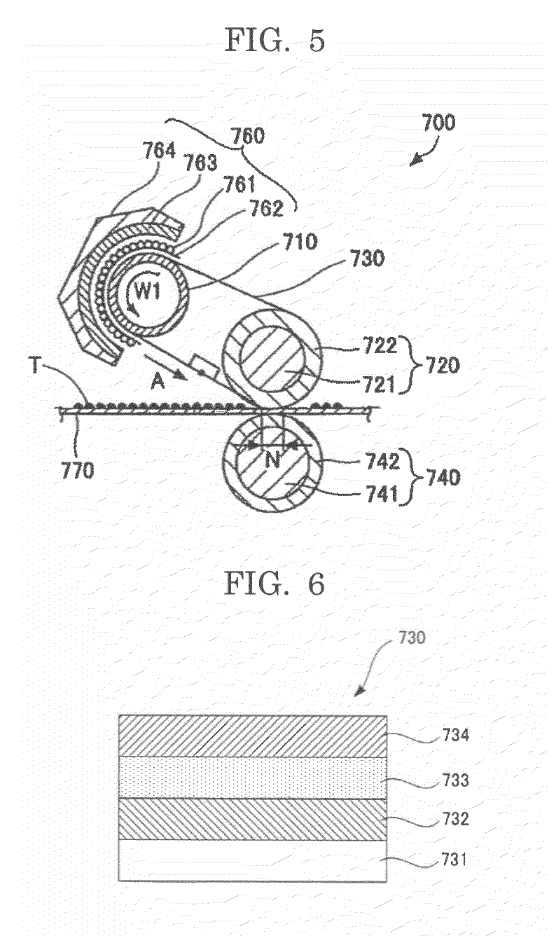

The fixing device (fixing unit) used in the image forming method of the present invention may be a fixing device shown in FIG. 5. The fixing device 700 shown in FIG. 5 preferably includes a heating roller 710 which is heated by electromagnetic induction by means of an induction heating unit 760, a fixing roller 720 (facing rotator) disposed in parallel to the heating roller 710, an endless fixing belt (heat resistant belt, toner heating medium) 730, which is formed of an endless strip stretched between the heating roller 710 and the fixing roller 720 and which is heated by the heating roller 710 and rotated by means of rotation of any of these rollers in the direction indicated by an arrow A, and a pressure roller 740 (pressing rotator) which is pressed against the fixing roller 720 through the fixing belt 730 and which is rotated in forward direction with respect to the fixing belt 730.

The heating roller 710 is a hollow cylindrical magnetic metal member made of, for example, iron, cobalt, nickel or an alloy of these metals. The heating roller 710 is 20 mm to 40 mm in an outer diameter, and 0.3 mm to 1.0 mm in thickness, to be in construction of low heat capacity and a rapid rise of temperature.

The fixing roller 720 (facing rotator) is formed of a metal core 721 made of metal such as stainless steel, and an elastic member 722 made of a solid or foam-like silicone rubber having heat resistance to be coated on the metal core 721. Further, to form a contact section of a predetermined width between the pressure roller 740 and the fixing roller 720 by a compressive force provided by the pressure roller 740, the fixing roller 720 is constructed to have an outer diameter of about 20 mm to about 40 mm, and to be larger than the heating roller 710. The elastic member 722 is about 4 mm to about 6 mm in thickness. Owing to this construction, the heat capacity of the heating roller 710 is smaller than that of the fixing roller 720, so that the heating roller 710 is rapidly heated to make warm-up time period shorter.

The fixing belt 730 that is stretched between the heating roller 710 and the fixing roller 720 is heated at a contact section W1 with the heating roller 710 to be heated by the induction heating unit 760. Then, an inner surface of the fixing belt 730 is continuously heated by the rotation of the heating roller 710 and the fixing roller 720, and as a result, the whole belt will be heated.

FIG. 6 shows a layer structure of the fixing belt 730. The fixing belt 730 consists of the following four layers in the order from an inner layer to a surface layer, a substrate 731, a heat generating layer 732, an intermediate layer 733, and a release layer 734.

The substrate 731 is formed preferably of a resin layer, for example, a polyimide (PI) resin. The heat generating layer 732 is a conductive material layer, for example, formed of Ni, Ag, SUS. The intermediate layer 733 is an elastic layer for uniform fixation. The release layer 734 is a resin layer, for example, formed of a fluorine-containing resin material for obtaining releasing effect and making oilless.

The release layer 734 preferably has a thickness of about 10 μm to about 300 μm, particularly preferably about 200 μm. In this manner, in the fixing device 700 as shown in FIG. 5, since the surface layer of the fixing belt 730 sufficiently covers a toner image T formed on a recording medium 770, it becomes possible to uniformly heat and melt the toner image T. The release layer 734; i.e., a surface release layer needs to have a thickness of 10 μm at minimum in order to secure abrasion resistance over time. In addition, when the release layer 734 exceeds 300 μm in thickness, the heat capacity of the fixing belt 730 increases, resulting in a longer warm-up time period. Further, additionally, a surface temperature of the fixing belt 730 is unlikely to decrease in the toner-fixing step, a cohesion effect of melted toner at an outlet of the fixing portion cannot be obtained, and thus the so-called hot offset occurs in which a releasing property of the fixing belt 730 is lowered, and toner particles of the toner image T is attached onto the fixing belt 730. Moreover, as a substrate of the fixing belt 730, the heat generating layer 732 formed of a metal may be used, or the resin layer having heat resistance, such as a fluorine-containing resin, a polyimide resin, a polyamide resin, a polyamide-imide resin, a PEEK resin, a PES resin, and a PPS resin, may be used.

The pressure roller 740 is constructed of a cylindrical metal core 741 made of a metal having a high thermal conductivity, for example, copper or aluminum, and an elastic member 742 having a high heat resistance and toner releasing property that is located on the surface of the metal core 741. The metal core 741 may be made of SUS other than the above-described metals. The pressure roller 740 presses the fixing roller 720 through the fixing belt 730 to form a nip portion N. According to this embodiment, the pressure roller 740 is arranged to engage into the fixing roller 720 (and the fixing belt 730) by causing the hardness of the pressure roller 740 to be higher than that of the fixing roller 720, whereby the recording medium 770 is in conformity with the circumferential shape of the pressure roller 740, thus to provide the effect that the recording medium 770 is likely to come off from the surface of the fixing belt 730. This pressure roller 740 has an external diameter of about 20 mm to about 40 mm, which is the same as that of the fixing roller 720. However, the pressure roller 740 has a thickness of about 0.5 mm to about 2.0 mm, and is formed thinner than the fixing roller 720.

The induction heating unit 760 for heating the heating roller 710 by electromagnetic induction, as shown in FIG. 5, includes an exciting coil 761 serving as a field generation unit, and a coil guide plate 762 around which this exciting coil 761 is wound. The coil guide plate 762 has a semi-cylindrical shape that is located close to the perimeter surface of the heating roller 710. The exciting coil 761 is the one in which one long exciting coil wire is wound alternately in an axial direction of the heating roller 710 along this coil guide plate 762. Further, in the exciting coil 761, an oscillation circuit is connected to a driving power source (not shown) of variable frequencies. Outside of the exciting coil 761, an exciting coil core 763 of a semi-cylindrical shape that is made of a ferromagnetic material such as ferrites is fixed to an exciting coil core support 764 to be located in the proximity of the exciting coil 761.

### <Cleaning Step and Cleaning Unit>

The cleaning step is a step of removing a residual toner remaining on the latent electrostatic image bearing member and is preferably carried out by a cleaning unit.

The cleaning unit is not particularly limited and may be appropriately selected from those known in the art depending on the intended purpose, as long as it can remove the toner remaining and adhering onto the surface of the latent electrostatic image bearing member. Examples thereof include a magnetic brush cleaner, an electrostatic brush cleaner, a magnetic roller cleaner, a cleaning blade, a brush cleaner, and a web cleaner. Of these, cleaning blades are particularly preferable in view of higher toner-removing ability, compact size, and low cost thereof.

Examples of rubber materials used for the cleaning rubber blade include urethane rubber, silicone rubber, fluorine rubber, chloroprene rubber, and butadiene rubber. Of these, urethane rubber is particularly preferable.

### <Other Steps and Other Units>

The charge eliminating step is a step of charge eliminating by applying a charge eliminating bias to the latent electrostatic image bearing member using a charge eliminating unit.

The charge eliminating unit is not particularly limited and may be appropriately selected from known charge eliminating devices, as long as it can apply a charge eliminating bias to the latent electrostatic image bearing member. Examples thereof include charge eliminating lamps.

The charge eliminating unit is not particularly limited as long as it can apply a charge eliminating bias to the latent electrostatic image bearing member, and may be appropriately selected from known charge eliminating devices. Examples thereof include charge eliminating lamps.

The recycling step is a step of recycling the toner removed by the cleaning step to the developing unit, and can be preferably carried out by a recycling unit. The recycling unit is not particularly limited and may be appropriately selected from known conveying units.

The controlling step is a step of controlling each of the above-mentioned steps and can be preferably carried out by a controlling unit.

The controlling unit is not particularly limited and may be appropriately selected depending on the intended purpose, as long as it is capable of controlling the operations of each of the units. Examples thereof include equipments such as sequencers and computers.

Hereinafter, one embodiment of the image forming method of the present invention carried out by means of the image forming apparatus of the present invention will be described with reference to Figures.

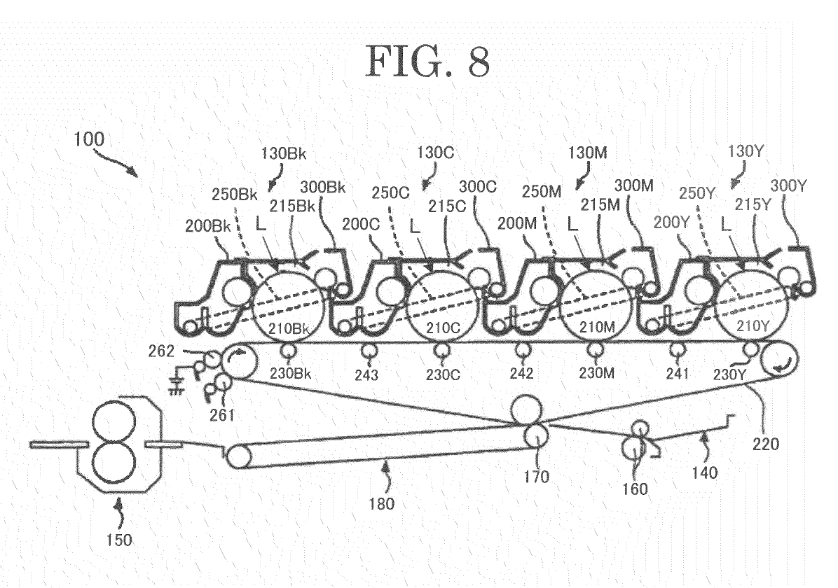

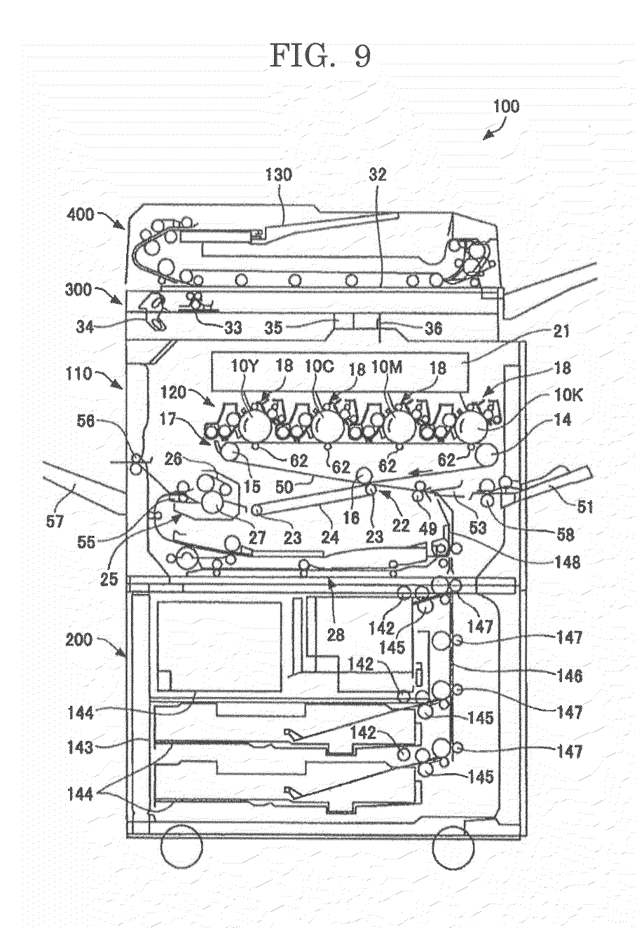

For example, a tandem image forming apparatus 100 shown in FIGS. 8 and 9 may be used. In FIG. 8, the image forming apparatus 100 mainly includes image writing units (not shown) for color image formation by an electrophotographic method, image forming units 130Bk, 130C, 130M and 130Y, and a paper feeder 140. According to image signals, image processing is performed in an image processing unit (not shown) to convert to respective color signals of black (Bk), cyan (C), magenta (M), and yellow (Y) for image formation, and the color signals are sent to the image wiring units. The image writing units are a laser scanning optical system that includes, for example, a laser beam source, a deflector such as a rotary polygon mirror, a scanning imaging optical system, and a group of mirrors (all not shown), has four writing optical paths corresponding to the color signals, and performs image writing according to the color signals in the image forming units 130Bk, 130C, 130M and 130Y.

The image forming units 130Bk, 130C, 130M and 130Y include photoconductors 210Bk, 210C, 210M and 210Y respectively for black, cyan, magenta, and yellow. An organic photoconductor (OPC) is generally used in the photoconductors 210Bk, 210C, 210M and 210Y for the respective colors. For example, charging devices 215Bk, 215C, 215M and 215Y, the image writing units (exposing units) for emitting laser beams L (shown with arrows in FIG. 8) therefrom, developing devices 200Bk, 200C, 200M and 200Y for respective colors, primary transfer devices 230Bk, 230C, 230M and 230Y, cleaning devices 300Bk, 300C, 300M and 300Y, and charge-eliminating devices (not shown) are provided around the respective photoconductors 210Bk, 210C, 210M and 210Y. The developing devices 200Bk, 200C, 200M and 200Y use a two-component magnetic brush development system. Further, an intermediate transfer belt 220 is interposed between the photoconductors 210Bk, 210C, 210M and 210Y and the primary transfer devices 230Bk, 230C, 230M and 230Y. Color toner images are successively transferred from respective photoconductors onto an intermediate transfer belt 220 to form superimposed toner images thereon.

The intermediate transfer belt 220 is preferably a single resin layer, if necessary, further includes an elastic layer and a surface layer.

In some cases, a pre-transfer charger is preferably provided as a pre-transfer charging unit at a position that is outside the intermediate transfer belt 220 and after the passage of the final color through a primary transfer position and before a secondary transfer position. Before the toner images on the intermediate transfer belt 220, which have been transferred onto the photoconductors 210Bk, 210C, 210M and 210Y in the primary transfer unit, are transferred onto a transfer paper as a recording medium, the pre-transfer charger charges toner images evenly to the same polarity.

The toner images on the intermediate transfer belt 220 transferred from the photoconductors 210Bk, 210C, 210M and 210Y include a halftone portion and a solid image portion or a portion in which the level of superimposition of toners is different. Accordingly, in some cases, the charge amount varies from a toner image to a toner image. Further, due to separation discharge generated in spaces on an adjacent downstream side of the primary transfer unit in the direction of movement of the intermediate transfer belt, a variation in charge amount may occur within toner images on the intermediate transfer belt 220 after the primary transfer. The variation in charge amount within the same toner image disadvantageously decreases a transfer latitude in the secondary transfer unit that transfers the toner images from the intermediate transfer belt 220 onto the transfer paper. Accordingly, the toner images before transfer onto the transfer paper are evenly charged to the same polarity by the pre-transfer charger to eliminate the variation in charge amount within the same toner image and to improve the transfer latitude in the secondary transfer unit.

Thus, according to the image forming method wherein the toner images transferred from the photoconductors 210Bk, 210C, 210M and 210Y onto the intermediate transfer belt 220 are evenly charged by the pre-transfer charger, even when there are variations in charge amount of the toner images on the intermediate transfer belt 220, the transfer properties in the secondary transfer unit can be rendered almost constant over each portion of the toner images located on the intermediate transfer belt 220. Accordingly, the decrease in the transfer latitude in the transfer of the toner images onto the transfer paper can be suppressed, and the toner images can be stably transferred.

In the image forming method, the amount of charge applied by the pre-transfer charger varies depending upon the moving speed of the intermediate transfer belt 220 to be charged. For example, when the moving speed of the intermediate transfer belt 220 is slow, the period of time, for which the same part in the toner images on the intermediate transfer belt 220 passes through a section of charging by the pre-transfer charger, becomes longer. Therefore, in this case, the charge amount is increased. On the other hand, when the moving speed of the intermediate transfer belt 220 is high, the charge amount of the toner images on the intermediate transfer belt 220 is decreased. Accordingly, when the moving speed of the intermediate transfer belt 220 changes during the passage of the toner images on the intermediate transfer belt 220 through the position of charging by the pre-transfer charger, preferably, the pre-transfer charger is regulated according to the moving speed of the intermediate transfer belt 220 so that the charge amount of the toner images does not change during the passage of the toner images on the intermediate transfer belt 220 through the position of charging by the pre-transfer charger.

Conductive rollers 241, 242 and 243 are provided between the primary transfer devices 230Bk, 230C, 230M and 230Y. The transfer paper is fed from a paper feeder 140 and then is supported on a transfer belt 180 through a pair of registration rollers 160. At a portion where the intermediate transfer belt 220 comes into contact with the transfer belt 180, the toner images on the intermediate transfer belt 220 are transferred by a secondary transfer roller 170 onto the transfer paper to perform color image formation.

The transfer paper after image formation is transferred by a secondary transfer belt 180 to a fixing device 150 where the color image is fixed to provide a fixed color image. The toner remaining after transfer on the intermediate transfer belt 220 is removed form the belt by an intermediate transfer belt cleaning device.

The polarity of the toner on the intermediate transfer belt 220 before transfer onto the transfer paper has the same negative polarity as the polarity in the development. Accordingly, a positive transfer bias voltage is applied to the secondary transfer roller 170, and the toner is transferred onto the transfer paper. The nip pressure in this portion affects the transferability and significantly affects the fixing ability. The toner remaining after transfer and located on the intermediate transfer belt 220 is subjected to discharge electrification to positive polarity side; i.e., 0 to positive polarity, in a moment of the separation of the transfer paper from the intermediate transfer belt 220. Toner images formed on the transfer paper in jam or toner images in a non-image section of the transfer paper are not influenced by the secondary transfer and thus, maintain negative polarity.

The thickness of the photoconductor layer, the beam spot diameter of the optical system, and the quantity of light are 30 μm, 50 μm×60 μm, and 0.47 mW, respectively. The developing step is performed under such conditions that the charge (exposure side) potential VO of the photoconductor (black) 210Bk is −700 V, potential VL after exposure is −120 V, and the development bias voltage is −470 V, that is, the development potential is 350 V. The visible image of the toner (black) formed on the photoconductor (black) 210Bk is then subjected to transfer (intermediate transfer belt and transfer paper) and the fixing step and consequently is completed as an image. Regarding the transfer, all the colors are first transferred from the primary transfer devices 230Bk, 230C, 230M and 230Y to the intermediate transfer belt 220, followed by transferring to the transfer paper by applying bias to a separate secondary transfer roller 170.

Next, the photoconductor cleaning device will be described in detail. In FIG. 8, the developing devices 200Bk, 200C, 200M and 200Y are connected to respective cleaning devices 300Bk, 300C, 300M and 300Y through toner transfer tubes 250Bk, 250C, 250M and 250Y (dashed lines in FIG. 8). A screw (not shown) is provided within the toner transfer tubes 250Bk, 250C, 250M and 250Y, and the toners recovered in the cleaning devices 300Bk, 300C, 300M and 300Y are transferred to the respective developing devices 200Bk, 200C, 200M and 200Y.

A direct transfer system including a combination of four photoconductor drums with belt transfer has the following drawback. Specifically, upon abutting of the photoconductor against the transfer paper, paper dust adheres onto the photoconductor. Therefore, the toner recovered from the photoconductor contains paper dust and thus cannot be used, because in the image formation, an image deterioration such as toner dropouts occurs. Further, in a system including a combination of one photoconductor drum with an intermediate transfer, the adoption of the intermediate transfer has eliminated a problem of the adherence of paper dust onto the photoconductor upon transfer of an image onto the transfer paper. In this system, however, when recycling of the residual toner on the photoconductor is contemplated, the separation of the mixed color toners is practically impossible. The use of the mixed color toners as a black toner has been proposed. However, even when all the colors are mixed, a black color is not produced. Further, colors vary depending upon printing modes. Accordingly, in the one-photoconductor structure, recycling of the toner is impossible.

By contrast, in the full-color image forming apparatus, since the intermediate transfer belt 220 is used, the contamination with paper dust less occurs. Further, the adherence of paper dust onto the intermediate transfer belt 220 during the transfer onto the paper can also be prevented. Since each of the photoconductors 210Bk, 210C, 210M and 210Y uses independent respective color toners, there is no need to perform contacting and separating of the photoconductor cleaning devices 300Bk, 300C, 300M and 300Y. Accordingly, only the toner can be reliably recovered.

The positively charged toner remaining after transfer on the intermediate transfer belt 220 is removed by cleaning with a conductive fur brush 262 to which a negative voltage has been applied. A voltage can be applied to the conductive fur brush 262 in the same manner as in the application of the voltage to a conductive fur brush 261, except that the polarity is different. The toner remaining after transfer can be almost completely removed by cleaning with the two conductive fur brushes 261 and 262. The toner, paper dust, talc and the like, remaining unremoved by cleaning with the conductive fur brush 262 are negatively charged by a negative voltage of the conductive fur brush 262. The subsequent primary transfer of black is transfer by a positive voltage. Accordingly, the negatively charged toner and the like are attracted toward the intermediate transfer belt 220, and thus, the transfer to the photoconductor (black) 210Bk side can be prevented.

FIG. 9 shows another example of the image forming apparatus 100 used in the image forming method of the present invention, and is a copier quipped with an electrophotographic image forming apparatus of a tandem indirect transfer system. In FIG. 9, the copier includes a copier main body 110, a paper feed table 200 for mounting the copier main body 110, a scanner 300, which is arranged over the copier main body 110, and an automatic document feeder (ADF) 400, which is arranged over the scanner 300. The copier main body 110 has an endless belt intermediate transfer medium 50 in the center.

The intermediate transfer medium is stretched around three support rollers 14, 15, and 16 and rotates clockwise as shown in FIG. 9. An intermediate transfer medium cleaning device 17 for removing residual toner on the intermediate transfer medium 50 after image transfer is provided near the second support roller 15 of the three support rollers. A tandem image forming device 120 has four image forming units 18 for yellow, cyan, magenta, and black, on the intermediate transfer medium 50 stretched around the first support roller 14 and the second support roller 15, and are arranged side by side along the rotation direction thereof.

An exposing device 21 is provided over the tandem image forming device 120 as shown in FIG. 9. A secondary transfer device 22 is provided across the intermediate transfer medium 50 from the tandem image forming device 120. The secondary transfer unit 22 has an endless secondary transfer belt 24 stretched around a pair of rollers 23, and is arranged so as to press against the third support roller 16 via the intermediate transfer medium 50, thereby transferring an image carried on the intermediate transfer medium 50 onto a sheet. A fixing device 25 configured to fix the transferred image on the sheet is provided near the secondary transfer device 22. The fixing device 25 has an endless fixing belt 26 and a pressure roller 27 pressed against the fixing belt 26. The secondary transfer device 22 includes a sheet conveyance function in which the sheet on which the image has been transferred is conveyed to the fixing device 25. As the secondary transfer device 22, a transfer roller or a non-contact charge may be provided, however, these are difficult to provide in conjunction with the sheet conveyance function. A sheet reversing device 28 for turning over a transferred sheet to form images on both sides of a sheet is provided parallel to the tandem image forming device 120 and under the secondary transfer device 22 and fixing device 25.

When a copy is made using the color electrophotographic image forming apparatus, at first, a document is placed on a document table 130 of the automatic document feeder 400. Alternatively, the automatic document feeder 400 is opened, the document is placed onto a contact glass 32 of the scanner 300, and the automatic document feeder 400 is closed.

When an unillustrated start switch is pressed, a document placed on the automatic document feeder 400 is conveyed onto the contact glass 32. When the document is initially placed on the contact glass 32, the scanner 300 is immediately driven to operate a first carriage 33 and a second carriage 34. At the first carriage 33, light is applied from a light source to the document, and reflected light from the document is further reflected toward the second carriage 34. The reflected light is further reflected by a mirror of the second carriage 34 and passes through image-forming lens 35 into a read sensor 36 to thereby read the document.

When the start switch is pressed, one of the support rollers 14, 15 and 16 is rotated by an unillustrated drive motor, and as a result, the other two support rollers are rotated by the rotation of the driven support roller. In this way, the intermediate transfer medium 50 runs around the support rollers 14, 15 and 16. Simultaneously, the individual image forming units 18 respectively rotate their photoconductors 10K, 10M, 10C and 10Y to thereby form black, magenta, cyan, and yellow monochrome images on the photoconductors 10K, 10M, 10C and 10Y, respectively. With the conveyance of the intermediate transfer medium 50, the monochrome images are sequentially transferred to form a composite color image on the intermediate transfer medium 50.

Separately, when the start switch (not shown) is pressed, one of feeder rollers 142 of the paper feed table 200 is selectively rotated, sheets are ejected from one of multiple feeder cassettes 144 in a paper bank 143 and are separated in a separation roller 145 one by one into a feeder path 146, are transported by a transport roller 147 into a feeder path 148 in the main body of the image forming apparatus 100 and are bumped against registration rollers 49.

Alternatively, pressing the start switch rotates a paper feeding roller to eject sheets on a manual bypass tray 51, and the sheets are separated one by one on a separation roller 58 into a manual bypass feeder path 53 and are bumped against the registration rollers 49.

The registration rollers 49 are rotated synchronously with the movement of the composite color image on the intermediate transfer medium 50 to transport the sheet into between the intermediate transfer medium 50 and the secondary transfer device 22, and the composite color image is transferred onto the sheet by action of the secondary transfer device 22 to thereby form a color image.

The sheet on which the image has been transferred is conveyed by the secondary transfer device 22 into the fixing device 25, and then heat and pressure is applied to the sheet in the fixing device 25 to fix the transferred image. The sheet is changed its direction by action of a switch claw 55, and is ejected by an ejecting roller 56 to be stacked on an output tray 57. Alternatively, the moving direction of the paper is changed by the switching claw 55, and the paper is conveyed to the sheet reversing device 28 where it is reversed, and guided again to the transfer position in order that an image is formed also on the back surface thereof, then the paper is ejected by the ejecting roller 56 and stacked on the output tray 57.

On the other hand, in the intermediate transfer medium 50 after the image transfer, the toner, which remains on the intermediate transfer medium 50 after the image transfer, is removed by the intermediate transfer medium cleaning device 17, and the intermediate transfer medium 50 again gets ready for image formation by the tandem image forming device 120. The registration rollers 49 are generally used in a grounded state. Bias may also be applied to the registration rollers 49 to remove paper dust of the paper sheet.

### (Process Cartridge)

The process cartridge of the present invention includes at least a latent electrostatic image bearing member that bears a latent electrostatic image on the surface thereof and a developing unit configured to develop the latent electrostatic image borne on the surface of the latent electrostatic image bearing member using a toner to form a visible image and further includes appropriately selected other units in accordance with the necessity such as a charging unit, an exposing unit, a transfer unit, a cleaning unit and a charge eliminating unit.

The toner of the present invention is used as the toner.

The developing unit includes at least a developer container to house the toner and/or the developer and a developer bearing member to bear and convey the toner and/or the developer which is housed in the developer container and may further include a layer thickness controlling member for controlling the thickness of a toner layer to be carried by the developer bearing member. Specifically, any of the one-component developing unit and the two-component developer unit, which have been described hereinbefore in the sections of the image forming apparatus and image forming method, can be preferably used.

The charging unit, exposing unit, transfer unit, cleaning unit, and charge eliminating unit may be appropriately selected from those similar to ones mentioned above for the image forming apparatus.

The process cartridge is detachably provided in various types of electrophotographic image forming apparatuses, facsimiles, and printers, and particularly preferably be detachably mounted to the image forming apparatus of the present invention.

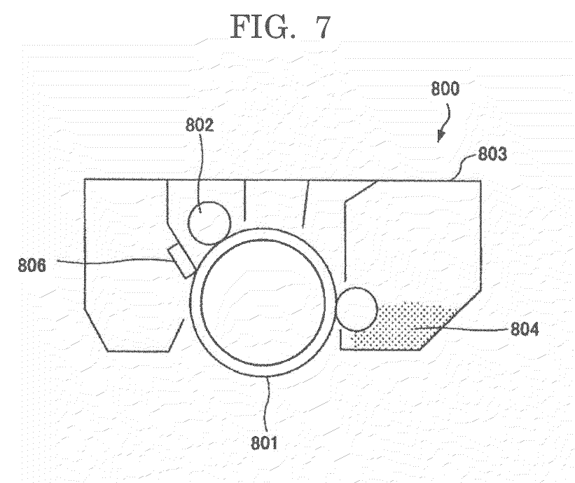

An example of the process cartridge is shown in FIG. 7. A process cartridge 800 shown in FIG. 7 includes a photoconductor 801, a charging unit 802, a developing unit 803, and a cleaning unit 806. In the operation of this process cartridge 800, the photoconductor 801 is rotated at a specific peripheral speed. In the course of rotating, the photoconductor 801 receives from the charging unit 802 a uniform, positive or negative electrical charge of a specific potential around its periphery, and then receives image exposure light from an image exposing unit (not shown), such as slit exposure or laser beam scanning exposure, and in this way a latent electrostatic image is formed on the periphery of the photoconductor 801. The latent electrostatic image thus formed is then developed by the developing unit 803, and the developed toner image is transferred by a transfer unit (not shown) onto a recording medium that is fed from a paper supplier to in between the photoconductor 801 and the transfer unit, in synchronization with the rotation of the photoconductor 801. The recording medium on which the image has been transferred is separated from the surface of the photoconductor 801, introduced into an unillustrated image fixing unit so as to fix the image thereon, and this product is printed out from the device as a copy or a print. The surface of the photoconductor 801 after the image transfer is cleaned by the cleaning unit 806 so as to remove the residual toner after the transfer, and is electrically neutralized and repeatedly used for image formation.

### EXAMPLES

The present invention will be described in more detail with reference to the following Examples and Comparative Examples. However, it should be noted that the present invention is not limited to these Examples and Comparative Examples.

### Example 1

### Toner Production

### —Synthesis of Unmodified Polyester Resin (Low Molecular Weight Polyester Resin)—

Into a reaction vessel equipped with a condenser, a stirrer, and a nitrogen-introducing tube, 67 parts by mass of bisphenol A ethylene oxide (2 mol) adduct, 84 parts by mass of bisphenol A propionoxide (3 mol) adduct, 274 parts by mass of terephthalic acid, and 2 parts by mass of dibutyltin oxide were charged, allowing the resultant mixture to react for 8 hours at 230° C. under normal pressure, so as to obtain a reaction liquid. Subsequently, the reaction liquid was allowed to react for 5 hours under reduced pressure of 10 mmHg to 15 mmHg, to thereby synthesize an unmodified polyester resin.

The thus-obtained unmodified polyester resin had a number average molecular weight (Mn) of 2,100, a weight average molecular weight (Mw) of 5,600, and a glass transition temperature, Tg, of 55° C.

### —Preparation of Masterbatch (MB)—

Water (1,000 parts by mass), 540 parts by mass of carbon black (“Printex 35” manufactured by Degussa, DBP oil absorption amount: 42 mL/100 g, pH 9.5), and 1,200 parts by mass of the unmodified polyester resin were mixed using HENSCHEL MIXER (manufactured by NIPPON COKE & ENGINEERING CO., LTD.), to obtain a mixture. The resultant mixture was kneaded at 150° C. for 30 minutes with a two-roller mill, and thereafter rolled and cooled, and pulverized with a pulverizer (manufactured by Hosokawa Micron Corporation), to thereby prepare masterbatch.

### —Synthesis of Prepolymer—

Into a reaction vessel equipped with a condenser, a stirrer, and a nitrogen-introducing tube, 682 parts by mass of bisphenol A ethylene oxide (2 mol) adduct, 81 parts by mass of bisphenol A propylene oxide (2 mol) adduct, 283 parts by mass of terephthalic acid, 22 parts by mass of trimellitic anhydride, and 2 parts by mass of dibutyltin oxide were charged, allowing the resultant mixture to react for 8 hours at 230° C. under normal pressure. Subsequently, the reaction mixture was allowed to react for 5 hours under reduced pressure of 10 mmHg to 15 mmHg, to thereby synthesize an intermediate polyester. The thus-obtained intermediate polyester had a number average molecular weight (Mn) of 2,100, a weight average molecular weight (Mw) of 9,600, a glass transition temperature, Tg, of 55° C., an acid value of 0.5 mgKOH/g, and a hydroxyl group value of 49 mgKOH/g.

Subsequently, into a reaction vessel equipped with a condenser, a stirrer, and a nitrogen-introducing tube, 411 parts by mass of the intermediate polyester, 89 parts by mass of isophorone diisocyanate, and 500 parts by mass of ethyl acetate were charged, allowing the resultant mixture to react for 5 hours at 100° C. to thereby synthesize a prepolymer, i.e., a polymer reactive with an active hydrogen group-containing compound.

The prepolymer thus obtained had a free isocyanate content of 1.60% by mass and solid content concentration of 50% by mass (150° C., after being left for 45 minutes).

### —Preparation of Acrylic Resin Fine Particles—

Into a reaction vessel equipped with a stirring rod and a thermometer, 683 parts by mass of water, 10 parts by mass of distearyl dimethyl ammonium chloride (Cation DS, manufactured by Sanyo Chemical Industries, Ltd.), 136 parts by mass of styrene, 136 parts by mass of methyl methacrylate, 2 parts by mass of ethylene glycol dimethacrylate, and 1 part by mass of ammonium persulfate were charged, and then stirred at 400 rpm for 15 minutes to thereby obtain a white emulsion. The emulsion was heated to a system temperature of 65° C. and was allowed to react for 10 hours. Then, 30 parts by mass of a 1% by mass aqueous ammonium persulfate solution was added to the reaction mixture, followed by aging at 75° C. for 5 hours, to thereby obtain an aqueous dispersion liquid of acrylic resin (styrene-methyl methacrylate) fine particles, i.e. acrylic resin fine particle dispersion liquid.

In the acrylic resin fine particle dispersion liquid, dispersion particles had a volume average particle diameter of 80 nm as measured with a particle size distribution analyzer, LA-920 (manufactured by Horiba, Ltd.), and Tg of 105° C. The acrylic resin fine particles had a weight average molecular weight of 80,000 as measured by GPC.

### —Preparation of Resin Fine Particles—

Into a reaction vessel equipped with a stirring rod and a thermometer, 683 parts by mass of water, 16 parts by mass of sodium salt of sulfuric acid ester of ethylene oxide adduct of methacrylic acid, ELEMINOL RS-30 (manufactured by Sanyo Chemical Industries Ltd.), 83 parts by mass of styrene, 83 parts by mass of methacrylic acid, 110 parts by mass of butyl acrylate, and 1 part by mass of ammonium persulfate were charged, and then stirred at 400 rpm for 15 minutes, to thereby obtain a white emulsion. The emulsion was heated to a system temperature of 75° C. and was allowed to react for 5 hours. Then, 30 parts by mass of a 1% by mass aqueous ammonium persulfate solution was added to the reaction mixture, followed by aging at 75° C. for 5 hours, to thereby obtain an aqueous dispersion liquid of a vinyl resin (a copolymer of styrene-methacrylic acid-butyl acrylate-sodium salt of sulfate ester of methacrylic acid-ethylene oxide adduct), i.e. resin fine particle dispersion liquid.

In the resin fine particle dispersion liquid, the dispersion particles had a volume average particle diameter of 42 nm, as measured with LA-920 (manufactured by Horiba, Ltd.).

### —Preparation of Solution or Dispersion Liquid—

The unmodified polyester resin (100 parts by mass) and 130 parts by mass of ethyl acetate were charged in a beaker, followed by stirring so as to dissolve the unmodified polyester resin in the ethyl acetate. Then, 10 parts by mass of carnauba wax (molecular weight: 1,800, acid value: 2.5 mgKOH/g, penetration: 1.5 mm (40° C.)), 10 parts by mass of the masterbatch, and 5 parts by mass of stearic acid (solid saturated fatty acid having 18 carbon atoms) were charged into the beaker. The resultant mixture was treated with a bead mill (“ULTRA VISCOMILL,” manufactured by AIMEX CO., Ltd.) under the following conditions: a liquid feed rate of 1 kg/hr, disc circumferential velocity of 6 m/s, 0.5 mm zirconia beads packed to 80% by volume, and 3 passes, to thereby produce a starting material solution. Further, 40 parts by mass of the prepolymer was added thereto, followed by stirring, to thereby prepare a solution or dispersion liquid. The dissolution or dispersion of the unmodified polyester resin and fatty acid was confirmed by visual observation.

### —Preparation of Aqueous Medium—

Water (660 parts by mass), 1.25 parts by mass of the resin fine particle dispersion liquid, 25 parts by mass of 48.5% by mass aqueous solution of sodium dodecyldiphenyl ether disulfonate ELEMINOL MON-7 (manufactured by Sanyo Chemical Industries Ltd.) and 60 parts by mass of ethyl acetate were mixed and stirred to obtain an opaque white liquid (aqueous phase). The acrylic resin fine particle dispersion liquid (50 parts by mass) was further added to the opaque white liquid. The liquid contained aggregates each in a size of several hundred micrometers as observed with an optical microscope. The aqueous medium phase was stirred at 8,000 rpm with a TK homomixer (manufactured by Tokushu Kika Kogyo Co., Ltd.). As a result, the aggregates were separated and dispersed into small aggregates each in a size of several micrometers, which was confirmed with the optical microscope. Therefore, it had been expected that the acrylic resin fine particles were dispersed and adhered to liquid droplets of the toner material component in the emulsification of the toner material performed after the preparation of the aqueous medium. The acrylic resin fine particles formed aggregates, but it was important that the aggregates were dispersed by shearing, so as to uniformly adhere to the toner surface.

### —Preparation of Emulsion or Dispersion Liquid—

The aqueous medium phase (150 parts by mass) was placed in a vessel, and then stirred at 12,000 rpm with a TK homomixer (manufactured by Tokushu Kika Kogyo Co., Ltd.). Subsequently, 100 parts by mass of the solution or dispersion liquid was added to the thus-treated aqueous medium phase, and the resultant mixture was mixed for 10 min to thereby prepare emulsion or dispersion liquid (emulsified slurry).

### —Removal of Organic Solvent—

A flask equipped with a degassing tube, a stirrer, and a thermometer was charged with 100 parts by mass of the emulsified slurry. The solvent was removed by stirring the emulsified slurry at a circumferential velocity of 20 m/min at 30° C. for 12 hours under reduced pressure, to thereby obtain a desolvated slurry.

### —Washing and Drying—

The whole amount of the desolvated slurry was filtrated under reduced pressure. Then, 300 parts by mass of ion-exchanged water was added to the filter cake, followed by mixing and redispersing with a TK homomixer at a rotation speed of 12,000 rpm for 10 min, and filtrating. Further, 300 parts by mass of ion-exchanged water was added to the filter cake, followed by mixing with a TK homomixer at a rotation speed of 12,000 rpm for 10 min and filtrating. This procedure was performed three times. The thus obtained filter cake was dried with a circular wind dryer at 45° C. for 48 hr. The dried product was sieved through a sieve with 75 μm-mesh opening, to thereby obtain toner base particles.

### —External Addition Treatment—

The toner base particles (100 parts by mass) were mixed with 0.6 parts by mass of hydrophobic silica having an average particle diameter of 100 nm, 1.0 part by mass of titanium oxide having an average particle diameter of 20 nm, and 0.8 parts by mass of a fine powder of hydrophobic silica having an average particle diameter of 15 nm using a HENSCHEL MIXER to produce a toner.

### <Production of Carrier>

The following materials for the carrier were dispersed with a homomixer for 10 min to prepare a solution for forming a coating film of an acrylic resin and a silicone resin containing alumina particles.

Carrier

| | |
|---|---|
| Acrylic resin solution (solid content: 50% by mass) | 21.0 parts by mass |
| Guanamine solution (solid content: 70% by mass) | 6.4 parts by mass |
| Alumina particles (particle diameter: 0.3 μm, | 7.6 parts by mass |
| specific resistance: 10¹⁴ Ω · cm) | |
| Silicone resin solution (solid content: 23% by mass, | 65.0 parts by mass |
| SR2410, manufactured by Dow Corning Toray | |
| Silicone Co., Ltd.) | |
| Aminosilane (solid content: 100% by mass, | 1.0 part by mass |
| SH6020, manufactured by Dow Corning Toray | |
| Silicone Co., Ltd.) | |
| Toluene | 60 parts by mass |
| Butyl cellosolve | 60 parts by mass |

The solution for forming a coating film was applied onto the surface of fired ferrite powder ((MgO)_{1.8}(MnO)_{49.5}(Fe₂O₃)_{48.0}, average particle diameter: 25 μm) serving as a core material, so as to have a thickness of 0.15 μm with SPILA COATER (manufactured by OKADA SEIKO CO., LTD.), followed by drying, to thereby obtain coated ferrite powder. The coated ferrite powder was allowed to stand in an electric furnace at 150° C. for one hour for firing. After cooling, the ferrite powder bulk was disintegrated with a sieve with an opening of 106 μm to obtain a carrier having a weight average particle diameter of 35 μm.

As to the measurement of the thickness of the coating film, since the coating film covering the surface of the carrier could be observed by observing the cross-section of the carrier under a transmission electron microscope, the average value of the thickness of the coating film was determined as the thickness thereof.

### <Production of Two-Component Developer>

A two-component developer was produced using the resultant toner and the carrier. Specifically, 7 parts by mass of the toner and 100 parts by mass of the carrier were uniformly mixed using a tubular mixer including a container that was tumbled for stirring, and then charged to thereby produce the two-component developer.

Next, using the resultant toner and the two-component developer, low temperature fixing ability, heat resistant storage stability, and resistance to carrier contamination (spent resistance) were evaluated as follows. The results are shown in Table 3.

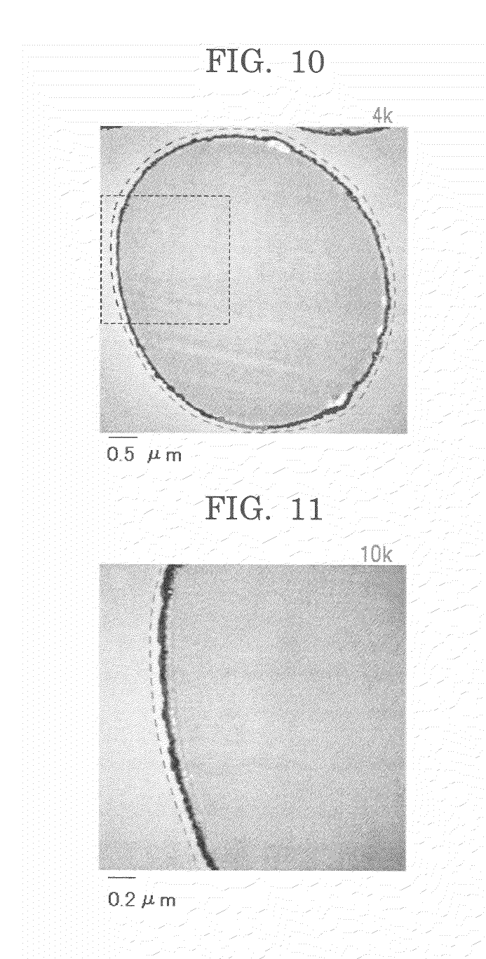

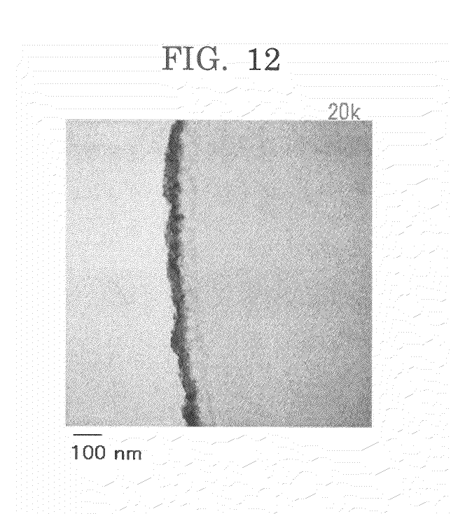

By TEM observation, a surface of a toner particle was observed and it was confirmed that acrylic resin fine particles were localized near the surface of the toner particle in the form of particles so as to form a layer of the particles. The location of the layer of the particles near the surface of the toner particle is shown in FIGS. 10 to 12.

Toners of Examples and Comparative Examples below were observed with respect to the layer of the particles in the same manner as described above, and those in which the layer of the particles was present near the surface of the toner particle, were denoted by “A” in Table 3.

### <Low Temperature Fixing Ability>

Using IMAGIO NEO 450 (manufactured by Ricoh Company, Ltd.), which was adjusted to form a solid image with a toner-adhesion amount of 1.0 mg/cm²±0.1 mg/cm² on plain paper and heavy paper, i.e., transfer paper Type 6200 (manufactured by Ricoh Company, Ltd.) and copy-printing paper <135> (manufactured by NBS Ricoh Co., Ltd.), and a fixing belt, which was adjusted to change its temperature, the lower limit temperature at which no hot offset occurred on the plain paper was measured and the low temperature fixing ability was evaluated. The evaluation was performed based on the decrease of the lower limit fixing temperature of the toner by adding fatty acid to the toner containing no fatty acid.

The evaluation criteria are as follows.

A: The lower limit fixing temperature decreased by 20° C. or higher.

B: The lower limit fixing temperature decreased by 15° C. or higher and less than 20° C.

C: The lower limit fixing temperature decreased by 10° C. or higher and less than 15° C.

D: The lower limit fixing temperature decreased by 5° C. or higher and less than 10° C.

E: The lower limit fixing temperature decreased by 0° C. or higher and less than 5° C.

### <Heat Resistant Storage Stability>

The toner was left to stand at a temperature of 40° C. and humidity of 70% for 2 weeks, and then the toner was sieved with a 75-μm mesh, and a certain vibration was applied thereto. The amount of the residual toner aggregates on the sieve was measured.

The evaluation criteria are as follows.

A: The amount of the toner aggregates was less than 0.5 mg.

B: The amount of the toner aggregates was 0.5 mg or more and less than 1.0 mg.

C: The amount of the toner aggregates was 1.0 mg or more.

### <Resistance to Carrier Contamination (Spent Resistance)>

An evaluation machine, which was a modified machine of DOCUCOLOR 8000 DIGITAL PRESS manufactured by Fuji Xerox Co., Ltd. and subjected to tuning so that the linear velocity and the transfer time could be adjusted, was provided. Using the evaluation machine, each developer was subjected to a 100,000-sheet running test in which a solid image pattern of size A4 at a toner adhesion amount of 0.6 mg/cm² was outputted as a test image. As an index of the resistance to carrier contamination, the developers every 1,000th sheet were sampled and charge amounts thereof were measured by a blow off method. The charge amount of the toner before the 100,000-sheet running test was compared with the charge amount thereof after the 100,000-sheet running test, to thereby evaluate the resistance to carrier contamination.

The evaluation criteria are as follows.

A: The decrease of the charge amount was less than 5 μc/g.

B: The decrease of the charge amount was 5 uc/g or more and less than 10 μc/g.

C: The decrease of the charge amount was 10 μc/g or more.

### Example 2

A toner was produced in the same manner as in Example 1, except that the stearic acid was replaced with capric acid. Thereafter, a two-component developer was produced in the same manner as in Example 1. The capric acid used in the toner was solid saturated fatty acid having 10 carbon atoms.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 2 were superior in the plasticizing effect (low temperature fixing ability) to those of Example 1, and were not problematic in practical use with respect to the heat resistant storage stability and the resistance to carrier contamination. The results are shown in Table 3.

### Example 3

A toner was produced in the same manner as in Example 1, except that the stearic acid was replaced with lauric acid. Thereafter, a two-component developer was produced in the same manner as in Example 1. The lauric acid used in the toner was solid saturated fatty acid having 12 carbon atoms.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 3 were superior in the plasticizing effect (low temperature fixing ability) to those of Example 1, and were not problematic in practical use with respect to the heat resistant storage stability and the resistance to carrier contamination. The results are shown in Table 3.

### Example 4

A toner was produced in the same manner as in Example 1, except that the stearic acid was replaced with palmitic acid. Thereafter, a two-component developer was produced in the same manner as in Example 1. The palmitic acid used in the toner was solid saturated fatty acid having 16 carbon atoms.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 4 were the same level in the plasticizing effect (low temperature fixing ability) to those of Example 1, and were not problematic in practical use with respect to the heat resistant storage stability and the resistance to carrier contamination. The results are shown in Table 3.

### Example 5

A toner was produced in the same manner as in Example 1, except that the stearic acid was replaced with oleic acid. Thereafter, a two-component developer was produced in the same manner as in Example 1. The oleic acid used in the toner was liquid fatty acid having 18 carbon atoms and one double bond.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 5 were superior in the plasticizing effect (low temperature fixing ability) to those of Example 1, and were not problematic in practical use. Moreover, the toner and two-component developer of Example 5 were not problematic in practical use with respect to the heat resistant storage stability and the resistance to carrier contamination. The results are shown in Table 3.

### Example 6

A toner was produced in the same manner as in Example 1, except that the stearic acid was replaced with linoleic acid. Thereafter, a two-component developer was produced in the same manner as in Example 1. The linoleic acid used in the toner was liquid fatty acid having 18 carbon atoms and two double bonds.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 6 were superior in the plasticizing effect (low temperature fixing ability) to those of Example 1, and were not problematic in practical use with respect to the heat resistant storage stability and the resistance to carrier contamination. The results are shown in Table 3.

### Example 7

A toner was produced in the same manner as in Example 1, except that the stearic acid was replaced with erucic acid. Thereafter, a two-component developer was produced in the same manner as in Example 1. The erucic acid used in the toner was solid fatty acid having 22 carbon atoms and one double bond.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 7 were slightly inferior in the plasticizing effect (low temperature fixing ability) to those of Example 1, and were not problematic in practical use with respect to the heat resistant storage stability and the resistance to carrier contamination. The results are shown in Table 3.

### Example 8

A toner was produced in the same manner as in Example 1, except that the stearic acid was replaced with caprylic acid. Thereafter, a two-component developer was produced in the same manner as in Example 1. The caprylic acid used in the toner was liquid saturated fatty acid having 8 carbon atoms.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 8 were superior in the plasticizing effect (low temperature fixing ability) to those of Example 1, and were not problematic in practical use with respect to the heat resistant storage stability and the resistance to carrier contamination. The results are shown in Table 3.

### Example 9

A toner was produced in the same manner as in Example 1, except that the stearic acid was replaced with caproic acid. Thereafter, a two-component developer was produced in the same manner as in Example 1. The caproic acid used in the toner was liquid saturated fatty acid having 6 carbon atoms.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 9 were the same level in the plasticizing effect (low temperature fixing ability) as those of Example 1, and were not problematic in practical use with respect to the heat resistant storage stability and the resistance to carrier contamination. The results are shown in Table 3.

### Example 10

A toner was produced in the same manner as in Example 1, except that the stearic acid was replaced with linolenic acid. Thereafter, a two-component developer was produced in the same manner as in Example 1. The linolenic acid used in the toner was liquid unsaturated fatty acid having 18 carbon atoms and one double bond.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 10 were slightly superior in the plasticizing effect (low temperature fixing ability) to those of Example 1, and were not problematic in practical use with respect to the heat resistant storage stability and the resistance to carrier contamination. The results are shown in Table 3.

### Example 11

A toner was produced in the same manner as in Example 3, except that the amount added of lauric acid was changed to 0.9 parts by mass relative to 100 parts by mass of the unmodified polyester resin. Thereafter, a two-component developer was produced in the same manner as in Example 3.

By using the resultant toner and two-component developer, the low temperature fixing ability, heat resistant storage stability, and location of the layer of the particles near the surface of the toner particle by TEM observation were evaluated in the same manner as in Example 1.

As a result, the toner and two-component developer of Example 11 were slightly superior in the plasticizing effect (low temperature fixing ability) to those of Example 3. The results are shown in Table 3.

### Example 12

A toner was produced in the same manner as in Example 3, except that the amount added of lauric acid was changed to 1 part by mass relative to 100 parts by mass of the unmodified polyester resin. Thereafter, a two-component developer was produced in the same manner as in Example 3.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 12 were slightly inferior in the plasticizing effect (low temperature fixing ability) to those of Example 3, but fixation at low temperature could be desirably achieved. Moreover the toner and two-component developer of Example 12 were not problematic in practical use with respect to the heat resistant storage stability and the resistance to carrier contamination. The results are shown in Table 3.

### Example 13

A toner was produced in the same manner as in Example 3, except that the amount added of lauric acid was changed to 12 parts by mass relative to 100 parts by mass of the unmodified polyester resin. Thereafter, a two-component developer was produced in the same manner as in Example 3.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 13 were superior in the plasticizing effect (low temperature fixing ability) to those of Example 3, and were not problematic in practical use with respect to the heat resistant storage stability and the resistance to carrier contamination. The results are shown in Table 3.

### Example 14

A toner was produced in the same manner as in Example 3, except that the amount added of lauric acid was changed to 13 parts by mass relative to 100 parts by mass of the unmodified polyester resin. Thereafter, a two-component developer was produced in the same manner as in Example 3.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 14 were superior in the plasticizing effect (low temperature fixing ability) to those of Example 13, and heat resistant storage stability and the resistance to carrier contamination were not problematic in practical use. The results are shown in Table 3.

### Example 15

A toner was produced in the same manner as in Example 3, except that the amount added of lauric acid was changed to 14 parts by mass relative to 100 parts by mass of the unmodified polyester resin. Thereafter, a two-component developer was produced in the same manner as in Example 3.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 15 were superior in the plasticizing effect (low temperature fixing ability) to those of Example 13, and were not problematic in practical use with respect to the heat resistant storage stability and the resistance to carrier contamination. The results are shown in Table 3.

### Example 16

A toner was produced in the same manner as in Example 3, except that the amount added of lauric acid was changed to 20 parts by mass relative to 100 parts by mass of the unmodified polyester resin. Thereafter, a two-component developer was produced in the same manner as in Example 1.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 16 were superior in the plasticizing effect (low temperature fixing ability), and were slightly inferior in the heat resistant storage stability and the resistance to carrier contamination to those of Example 3, but were not problematic in practical use. The results are shown in Table 3.

### Example 17

A toner was produced in the same manner as in Example 3, except that the amount added of lauric acid was changed to 21.0 parts by mass relative to 100 parts by mass of the unmodified polyester resin. Thereafter, a two-component developer was produced in the same manner as in Example 3.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 17 were slightly inferior in the heat resistant storage stability to those of Example 3. The results are shown in Table 3.

### Comparative Example 1

A toner was produced in the same manner as in Example 1, except that the stearic acid was replaced with valeric acid (solid saturated fatty acid having 4 carbon atoms). Thereafter, a two-component developer was produced in the same manner as in Example 1.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Comparative Example 1 exhibited plasticizing effect (low temperature fixing ability), but the toner material such as wax, etc. significantly transferred to the aqueous phase, and improvement could not be expected. The results are shown in Table 3.

### Comparative Example 2

A toner was produced in the same manner as in Example 1, except that the stearic acid was replaced with montanic acid. Thereafter, a two-component developer was produced in the same manner as in Example 1. The montanic acid used in the toner was solid saturated fatty acid having 30 carbon atoms.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Comparative Example 2 exhibited plasticizing effect (low temperature fixing ability), but the montanic acid did not dissolve in ethyl acetate, and a dispersant was required to take the montanic acid into the toner. However, the dispersant adversely affected the lower limit fixing temperature, and fixation at low temperature could not be expected. The results are shown in Table 3.

### Comparative Example 3

A toner was produced in the same manner as in Example 1, except that the stearic acid was not used. Thereafter, a two-component developer was produced in the same manner as in Example 1.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Comparative Example 3 did not exhibit plasticizing effect (low temperature fixing ability). Thus, it was difficult to achieve fixation at low temperature, and improvement could not be expected. The results are shown in Table 3.

The binder resin obtained in Example 1 and each of the fatty acids shown in Table 1 were mixed, and heated so as to form a solution, and then the physical properties of the solution was evaluated. The results are shown in Table 1.

In “ethyl acetate solubility” in Table 1, “A” represents that the binder resin dissolved in ethyl acetate, and “B” represents that the binder resin did not dissolve in ethyl acetate.

TABLE 1

| Fatty acid | | | | Binder resin | | |
|---|---|---|---|---|---|---|
| | Number of | Number of | Amount added | Amount added | Tg | Ethyl acetate |
| Type | carbon atom | double bond | (parts by mass) | (parts by mass) | (° C.) | solubility |
| stearic acid | 18 | 0 | 5 | 100 | 37 | A |
| capric acid | 10 | 0 | 5 | 100 | 33 | A |
| lauric acid | 12 | 0 | 5 | 100 | 34 | A |
| palmitic acid | 16 | 0 | 5 | 100 | 37 | A |
| oleic acid | 18 | 1 | 5 | 100 | 36 | A |
| linoleic acid | 18 | 2 | 5 | 100 | 33 | A |
| erucic acid | 22 | 1 | 5 | 100 | 38 | A |
| caprylic acid | 8 | 0 | 5 | 100 | 33 | A |
| caproic acid | 6 | 0 | 5 | 100 | 32 | A |
| linolenic acid | 18 | 3 | 5 | 100 | 30 | A |
| lauric acid | 12 | 0 | 0.9 | 100 | 44 | A |
| lauric acid | 12 | 0 | 1 | 100 | 42 | A |
| lauric acid | 12 | 0 | 12 | 100 | 32 | A |
| lauric acid | 12 | 0 | 13 | 100 | 32 | A |
| lauric acid | 12 | 0 | 14 | 100 | 31 | A |
| lauric acid | 12 | 0 | 20 | 100 | 29 | A |
| lauric acid | 12 | 0 | 21 | 100 | 28 | A |
| valeric acid | 5 | 0 | 5 | 100 | 37 | A |
| montanic acid | 28 | 0 | 5 | 100 | 37 | B |
| — | — | — | — | 100 | 55 | — |

The physical properties of the toners obtained in Examples 1 to 17 and Comparative Examples 1 to 3 are shown in Table 2.

TABLE 2

| | | Amount of | Amount of | | | | | | | |
|---|---|---|---|---|---|---|---|---|---|---|
| | | fatty acid | fatty acid | Amount of | | | Volume | | | BET |
| | | (parts by | (parts by | fatty acid | | | average | Particle | | specific |
| | | mass)/toner | mass)/binder | (% by mass)/ | Ethyl | | particle | size | | surface |
| | | (100 parts | resin (100 | ethyl | acetate | Tg | diameter | distribution | Average | area |
| | Fatty acid | by mass) | parts by mass) | acetate | solubility | (° C.) | (μm) | Dv/Dn | circularity | (m²/g) |
| Ex. 1 | stearic acid | 5 | 5 | 3.8 | A | 40 | 5.2 | 1.13 | 0.962 | 2.8 |
| Ex. 2 | capric acid | 5 | 5 | 3.8 | A | 36 | 5.1 | 1.13 | 0.968 | 3 |
| Ex. 3 | lauric acid | 5 | 5 | 3.8 | A | 37 | 5.3 | 1.13 | 0.968 | 3.1 |
| Ex. 4 | palmitic acid | 5 | 5 | 3.8 | A | 40 | 5.2 | 1.14 | 0.963 | 2.9 |
| Ex. 5 | oleic acid | 5 | 5 | 3.8 | A | 39 | 5.2 | 1.13 | 0.965 | 2.8 |
| Ex. 6 | linoleic acid | 5 | 5 | 3.8 | A | 36 | 5.2 | 1.13 | 0.966 | 2.8 |
| Ex. 7 | erucic acid | 5 | 5 | 3.8 | A | 41 | 5.1 | 1.15 | 0.967 | 2.9 |
| Ex. 8 | caprylic acid | 5 | 5 | 3.8 | A | 36 | 5.4 | 1.12 | 0.968 | 2.7 |
| Ex. 9 | caproic acid | 5 | 5 | 3.8 | A | 35 | 5.2 | 1.14 | 0.967 | 2.6 |
| Ex. 10 | linolenic acid | 5 | 5 | 3.8 | A | 33 | 5.3 | 1.13 | 0.965 | 2.4 |
| Ex. 11 | lauric acid | 0.9 | 0.9 | 0.7 | A | 47 | 5.2 | 1.14 | 0.967 | 3.2 |
| Ex. 12 | lauric acid | 1 | 1 | 0.8 | A | 45 | 5.1 | 1.12 | 0.966 | 3.3 |
| Ex. 13 | lauric acid | 12 | 12 | 9.2 | A | 35 | 5.2 | 1.13 | 0.965 | 2.9 |
| Ex. 14 | lauric acid | 13 | 13 | 10.0 | A | 35 | 5.3 | 1.14 | 0.968 | 2.9 |
| Ex. 15 | lauric acid | 14 | 14 | 10.8 | A | 34 | 5.1 | 1.14 | 0.966 | 2.8 |
| Ex. 16 | lauric acid | 20 | 20 | 15.4 | A | 32 | 5.2 | 1.15 | 0.969 | 2.3 |
| Ex. 17 | lauric acid | 21 | 21 | 16.2 | A | 31 | 5.2 | 1.14 | 0.966 | 2.2 |
| Comp. Ex. 1 | valeric acid | 5 | 5 | 3.8 | A | 40 | 5.3 | 1.13 | 0.966 | 3.1 |
| Comp. Ex. 2 | montanic acid | 5 | 5 | 3.8 | B | 40 | — | — | — | 3 |
| Comp. Ex. 3 | — | — | — | — | — | 50 | 5.2 | 1.13 | 0.966 | 3.5 |

The physical properties of the toner and two-component developer obtained in Examples 1 to 17 and Comparative Examples 1 to 3 are shown in Table 3.

TABLE 3

| | Evaluation | | | |
|---|---|---|---|---|
| | Low | Heat | | |
| | temperature | resistant | Resistance to | |
| | fixing | storage | carrier | Layer of |
| | ability | stability | contamination | particles |
| Ex. 1 | C | A | A | A |
| Ex. 2 | B | A | A | A |
| Ex. 3 | B | A | A | A |
| Ex. 4 | C | A | A | A |
| Ex. 5 | B | A | A | A |
| Ex. 6 | B | A | A | A |
| Ex. 7 | D | A | A | A |
| Ex. 8 | B | A | A | A |
| Ex. 9 | C | A | A | A |
| Ex. 10 | B | A | A | A |
| Ex. 11 | C | A | A | A |
| Ex. 12 | C | A | A | A |
| Ex. 13 | A | A | A | A |
| Ex. 14 | A | A | A | A |
| Ex. 15 | A | A | A | A |
| Ex. 16 | A | A | A | A |
| Ex. 17 | C | B | A | A |
| Comp. Ex. 1 | C | C | C | A |
| Comp. Ex. 2 | E | A | A | A |
| Comp. Ex. 3 | E | A | A | A |

### Comparative Example 4

A toner was produced in the same manner as in Example 1, except that the acrylic resin fine particles were not used. Upon emulsification, the significant amount of oil droplet aggregates were formed, and a toner could not be obtained.

### Example 18

A toner was produced in the same manner as in Example 1, except that in the preparation of the acrylic resin fine particles, the charging amount of methyl methacrylate was changed to 180 parts by mass, and that the glass transition temperature Tg was decreased to 65° C. Thereafter, a two-component developer was produced in the same manner as in Example 1.

By using the resultant toner and two-component developer, the low temperature fixing ability, heat resistant storage stability, and location of the layer of the particles near the surface of the toner particle by TEM observation were evaluated in the same manner as in Example 1. As a result, fixation at a lower temperature could be achieved, but the toner and two-component developer of Example 11 were inferior in the heat resistant storage stability to those of Example 1.

### <Evaluation Results>

Ethyl acetate solubility: A

Low temperature fixing ability: C

Heat resistant storage stability: B

Resistance to carrier contamination: A

Layer of Particles: A

### Example 19

A toner was produced in the same manner as in Example 1, except that acrylic resin fine particles having a weight average molecular weight of 30,000 was used. Thereafter, a two-component developer was produced in the same manner as in Example 1.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 12 were slightly inferior in the low temperature fixing ability to those of Example 1, and were the same level in the heat resistant storage stability and the resistance to carrier contamination as those of Example 1.

### <Evaluation Results>

Ethyl acetate solubility: A

Low temperature fixing ability: D

Heat resistant storage stability: A

Resistance to carrier contamination: A

Layer of particles: A

### Example 20

A toner was produced in the same manner as in Example 1, except that the acrylic resin fine particles having a volume average particle diameter of 80 nm were replaced with acrylic resin fine particles having a volume average particle diameter of 100 nm. Thereafter, a two-component developer was produced in the same manner as in Example 1.

By using the resultant toner and two-component developer, the low temperature fixing ability, heat resistant storage stability, and location of the layer of the particles near the surface of the toner particle by TEM observation were evaluated in the same manner as in Example 1. As a result, the toner and two-component developer of Example 13 were the same level in the low temperature fixing ability and the heat resistant storage stability as those of Example 1, but were slightly inferior in the resistance to carrier contamination to those of Example 1.

### <Evaluation Results>

Ethyl acetate solubility: A

Low temperature fixing ability: C

Heat resistant storage stability: A

Resistance to carrier contamination: B

Layer of particles: A

The toner of the present invention has excellent low temperature fixing ability, spent resistance and heat resistant storage stability in full color image forming method, and thus high quality images can be stably obtained using the toner, and the toner can be suitably used in various electrophotographic image formation.

What is claimed is:

1. A toner comprising:
a fatty acid having 6 to 22 carbon atoms; and
a binder resin,
wherein the toner is obtained by a method for producing a toner, which comprises:
dissolving or dispersing in an organic solvent the fatty acid having 6 to 22 carbon atoms, and a toner material containing at least the binder resin, so as to prepare a solution or dispersion liquid;
emulsifying or dispersing the solution or dispersion liquid in an aqueous medium containing acrylic resin fine particles, so as to prepare an emulsion or dispersion liquid; and
removing the organic solvent from the emulsion or dispersion liquid.

2. The toner according to claim 1, wherein the fatty acid is in a form of liquid or solid at 25° C.±5° C.

3. The toner according to claim 1, wherein the fatty acid in the organic solvent is 10% by mass or more.

4. The toner according to claim 1, wherein, in the dissolving or dispersing in the organic solvent, the amount of the fatty acid is 1.0 part by mass to 20.0 parts by mass, relative to 100 parts by mass of the binder resin.

5. The toner according to claim 1, wherein the fatty acid has 0 to 2 double bonds.

6. The toner according to claim 1, wherein the binder resin is a polyester resin.

7. The toner according to claim 1, wherein the binder resin has a glass transition temperature Tg of 30° C. to 70° C.

8. The toner according to claim 1, wherein an amount of the fatty acid is 0.1 parts by mass to 20.0 parts by mass, relative to 100 parts by mass of the toner.

9. The toner according to claim 1, wherein the toner has a glass transition temperature Tg of 20° C. to 55° C.

10. The toner according to claim 1, wherein the acrylic resin fine particles are localized near a surface of the toner in a form of particles, so as to form a layer of particles.

11. The toner according to claim 1, wherein the toner has a volume average particle diameter of 3 μm to 7 μm.

12. The toner according to claim 1, wherein a ratio of a volume average particle diameter to a number average particle diameter of the toner is 1.05 to 1.25.

13. The toner according to claim 1, wherein the toner has an average circularity of 0.950 to 0.990.

14. The toner according to claim 1, wherein the toner has a BET specific surface area of 0.5 m²/g to 4.0 m²/g.

15. The toner according to claim 1, wherein the toner material contains an active hydrogen group-containing compound, and a modified polyester resin reactive with the active hydrogen group-containing compound.

16. A developer comprising a toner, which comprises:
a fatty acid having 6 to 22 carbon atoms; and
a binder resin,
wherein the toner is obtained by a method for producing a toner, which contains:
dissolving or dispersing in an organic solvent the fatty acid having 6 to 22 carbon atoms, and a toner material containing at least the binder resin, so as to prepare a solution or dispersion liquid;
emulsifying or dispersing the solution or dispersion liquid in an aqueous medium containing acrylic resin fine particles, so as to prepare an emulsion or dispersion liquid; and
removing the organic solvent from the emulsion or dispersion liquid.

17. An image forming method comprising:
charging a surface of an electrophotographic photoconductor;
exposing the charged surface of the electrophotographic photoconductor to light so as to form a latent electrostatic image;
developing the latent electrostatic image using a toner so as to form a visible image;
transferring the visible image directly or via an intermediate transfer medium onto a recording medium;
fixing the transferred visible image onto the recording medium; and
cleaning the toner remaining on the surface of the electrophotographic photoconductor,
wherein the toner comprises:
a fatty acid having 6 to 22 carbon atoms; and
a binder resin,
wherein the toner is obtained by a method for producing a toner, which comprises:
dissolving or dispersing in an organic solvent the fatty acid having 6 to 22 carbon atoms, and a toner material containing at least the binder resin, so as to prepare a solution or dispersion liquid;
emulsifying or dispersing the solution or dispersion liquid in an aqueous medium containing acrylic resin fine particles, so as to prepare an emulsion or dispersion liquid; and
removing the organic solvent from the emulsion or dispersion liquid.

18. An image forming method according to claim 17, wherein the transferring the visible image via the intermediate transfer medium onto the recording medium is performed by a secondary transfer unit, a linear velocity of transferring the visible image onto the recording medium is 300 mm/sec to 1,000 mm/sec, and a transfer time at a nip portion in the secondary transfer unit is 0.5 msec to 20 msec.
